(19) United States
(12) Patent Application Publication
(10) Pub. No.: US 2026/0368776 A1
(43) Pub. Date: Nov. 19, 2026

(54) GENERATIVE ARTIFICIAL INTELLIGENCE USING CONTEXT INFORMATION

(71) Applicant: Microsoft Technology Licensing, LLC, Redmond, WA (US)

(72) Inventors: Shao Tang, Cupertino, CA (US); Zhipeng Wang, San Carlos, CA (US)

(73) Assignee: Microsoft Technology Licensing, LLC, Redmond, WA (US)

(21) Appl. No.: 19/211,607

(22) Filed: May 19, 2025

(51) Int. Cl. G06Q 30/0242; G06N 20/00

(52) U.S. Cl. CPC G06Q 30/0244; G06N 20/00; G06Q 30/0246

(57) ABSTRACT

A method comprises receiving a set of performance metrics for a content delivery campaign associated with an entity identifier, sending a prompt to a generative artificial intelligence (AI) agent, the prompt comprising the set of performance metrics and instructions for the generative AI model to generate a recommendation based on the set of performance metrics, the recommendation comprising digital content information and a conversion element for a graphical user interface (GUI), receiving the recommendation from the generative AI model, sending the recommendation to a reward model to generate a reward value for the recommendation, the reward value indicating whether the digital content information of the recommendation will cause the conversion element to generate an interaction event associated with the entity identifier, receiving the reward value for the recommendation from the reward model, and determining whether to select the recommendation for presentation on the GUI based on the reward value.

### BACKGROUND

Software applications harness the power of computer networks to distribute a wide variety of digital content to user computing devices. To assess the effectiveness of these content distribution systems, developers rely on “signals” generated at the recipient devices. These signals comprise measurable user interactions, including clicks, conversions, session durations, and a range of other user interface events. By analyzing these interactions, the reach and impact of a particular content delivery mechanism or ranking algorithm can be determined. The signals reveal whether the right audience is being targeted and engaged, and to what extent they respond to the distributed content. This feedback loop not only helps quantify performance but also guides the iterative refinement of ranking models, content personalization strategies, and overall user experience. Over time, the insights gleaned from these signals become invaluable for optimizing content distribution campaigns, ensuring that they are more closely aligned with evolving user preferences and behaviors.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a system in accordance with one embodiment.

FIG. 3 illustrates a content delivery system in accordance with one embodiment.

FIG. 4 illustrates a GUI view in accordance with one embodiment.

FIG. 5 illustrates a model architecture in accordance with one embodiment.

FIG. 6 illustrates a model architecture in accordance with one embodiment.

FIG. 7 illustrates a model architecture in accordance with one embodiment.

FIG. 8 illustrates a transformer model in accordance with one embodiment.

FIG. 9 illustrates a logic diagram in accordance with one embodiment.

FIG. 10 illustrates a logic flow in accordance with one embodiment.

FIG. 11 illustrates a logic flow in accordance with one embodiment.

FIG. 12 illustrates an apparatus in accordance with one embodiment.

FIG. 13 illustrates a logic diagram in accordance with one embodiment.

FIG. 14 illustrates a computing architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. For example, embodiments of the present disclosure comprise a content delivery system implementing an AI framework to generate customized recommendations for entities responsible for managing content delivery campaigns. The AI framework includes multiple ML models, such as a generative AI model and a reward model. The generative AI model, such as a large language model (LLM), and the reward model are jointly trained to optimize performance of the generative AI model. The generative AI model is designed to generate multi-modal information (e.g., text, visual, audio) for a recommendation to improve one or more performance metrics of a content delivery campaign. For example, the recommendation prompts an entity to modify a campaign attribute (e.g., a target audience) to increase a click through-rate (CTR), conversion rate (CVR), impressions, qualified leads, and other key performance indicators. The reward model evaluates the recommendation based on historical data associated with the entity or a cohort for the entity, such as past actions taken by the entity or the cohort. The reward model outputs a reward value to the generative AI model. The generative AI model uses the reward value for fine-tuning operations to generate improved recommendations. This process continues in an iterative manner until the generative AI model converges on a final recommendation for the entity. In this manner, the generative AI model generates recommendations (or insights) that optimize values for an entity (e.g., an advertiser) and the connection network system, based on past actions of the entity or cohort and respective campaign performance. Although exemplary embodiments are described in connection with a particular AI system or an ML model, the principles described herein can also be applied to other types of AI systems and ML models as well. Embodiments are not limited in this context.

### Overview

A connection network system is an online platform for professionals that fosters business connections, supports career advancement, and facilitates industry-specific collaborations. A connection network system is a membership-based service that caters to professionals, job seekers, recruiters, and companies of all sizes. Users can create in-depth profiles highlighting their work experience, education, skills, endorsements, and achievements, enabling them to network strategically, join interest-based groups, and stay informed on industry trends. In addition to its powerful networking capabilities, a connection network system integrates features that assist with job discovery, enabling individuals to receive personalized job recommendations, apply directly through the platform, and engage with potential employers. Companies leverage network services for talent acquisition, employer branding, company updates, and thought leadership activities, making it a central hub for building a professional presence. Furthermore, a connection network system offers an extensive catalog of courses to help users develop new skills, enhance their resumes, and reach their career goals, while the platform's publishing tools allow members to share original articles, insights, and multimedia content that can increase visibility and credibility. Together, these robust features create an indispensable resource for professionals seeking meaningful connections, professional growth, and valuable business opportunities across a wide array of industries.

A connection network system may provide access to a large amount of electronic content aimed at professional networking and career development. For example, a connection network system may list employment opportunities posted by employers across different industries, professional profiles with detailed information about entities of the connection network system (e.g., work experience, skills, and endorsements), articles or posts created by entities and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where entities can share ideas and discuss industry trends, and other types of content designed to facilitate professional growth and industry engagement.

Various types of entities may generate, modify, store, read, or otherwise interact with the electronic content of the connection network system. Non-limiting examples of entities include an individual, a person, an entity, a member, a subscriber, a corporate entity, a company, a business, an organization, a governmental agency, a community, a group, and the like. In some cases, the connection network system collects a variety of data associated with the various types of entities of the platform in accordance with privacy policies which govern how this information is collected, used, and shared. For an entity such as a user or member of the connection network system, the entity data may include basic profile information such as name, job title, industry, location, educational background, demographic information, work history, and so forth. For an entity such as a company, the entity data may also include basic profile information such as a company name, description, industry, business segment, jobs, careers, offices, geographic locations, and so forth. Additionally, the connection network system may collect activity data for entities representing various interactions and behaviors exhibited while on the platform. Examples of activity data including interactions between entities or interacting with electronic content of the connection network system, including profile updates, content engagement, search and navigation behavior, job activities, networking activities, group participation, skill endorsements and recommendations, advertisement engagement, learning activities, event participation, followers activities, interactions with external content, engagement patterns, behavioral trends, organic contents, sponsored contents, sales activities, marketing activities, conversion events, and so forth.

In some cases, a connection network system may enhance network services offered by the connection network system based on the entity data and activity data of its entities. Examples of network services include messaging services, search services, ranking services, recommendation services, advertising services, content delivery services, and so forth. For example, a connection network system may use activity data to personalize entity experiences, optimize content displayed in content feeds, improve targeted advertising, and enhance platform features. It also plays a role in developing analytics and reporting tools, helping entities and businesses understand their network reach, content effectiveness, and engagement with their audience.

For content delivery services, a connection network system implements a content delivery system to deliver content items, such as digital advertisements, to a target audience. The content delivery system includes a campaign manager application (“campaign manager”) that allows an entity, such as a user for an advertiser, to create a content delivery campaign, define campaign objectives, and select a target audience. For example, the campaign manager is designed to generate a graphical user interface (GUI) to present a comprehensive dashboard to track the performance of advertisement campaigns. The dashboard serves as a centralized hub, presenting key performance metrics such as impressions, click-through rates (CTR), conversion rates, cost per click (CPC), and engagement levels. These metrics are visualized through intuitive charts and graphs, allowing advertisers to monitor real-time data and assess how effectively their campaigns are reaching the intended audience. For instance, a high number of impressions but a low CTR might indicate that the ad is visible but not compelling enough to prompt user interaction. The dashboard also enables segmentation of data by demographics, job titles, industries, or geographic regions, providing granular insights into audience behavior and campaign performance.

The campaign manager leverages these metrics to generate actionable recommendations aimed at optimizing advertisement performance. By analyzing patterns in the data, the system identifies areas where the campaign may be underperforming and suggests adjustments to improve outcomes. For example, if the data shows that an ad is resonating more with mid-level professionals than senior executives, the campaign manager might recommend refining the target audience to focus on mid-level roles, thereby increasing relevance and engagement. Similarly, if conversions are higher in certain geographic regions, the system may suggest reallocating budget to those areas. These recommendations are often prioritized based on their potential impact, ensuring advertisers can focus on changes likely to yield the greatest return on investment.

To enhance the precision of its recommendations, the campaign manager employs machine learning algorithms that continuously learn from historical and real-time campaign data. These algorithms analyze trends across multiple campaigns to predict which adjustments are most likely to improve specific metrics. For instance, if campaigns targeting younger professionals consistently show higher engagement with video ads compared to static images, the system might recommend incorporating more video content into the campaign. Additionally, A/B testing capabilities allow advertisers to experiment with different ad creatives, messaging, or audience segments, with the campaign manager providing data-driven insights on which variations perform best. This iterative process ensures that recommendations remain relevant and aligned with evolving audience preferences.

The process of implementing recommendations is streamlined within the campaign manager, enabling advertisers to make adjustments directly through the platform. For example, an advertiser can modify the target audience by updating parameters such as age, industry, or job function, or adjust bidding strategies to optimize CPC or cost per acquisition (CPA). The dashboard provides immediate feedback on the impact of these changes, allowing advertisers to monitor whether the revised campaign aligns with their goals. If a recommendation does not yield the expected results, the system can propose alternative strategies, such as tweaking ad copy or experimenting with different call-to-action (CTA) phrases. This closed-loop system fosters continuous improvement and adaptability in campaign management.

Ultimately, the campaign manager provides data-driven recommendations that empower advertisers to maximize the effectiveness of their campaigns on the professional networking platform. By combining robust metrics with intelligent insights, the campaign manager simplifies the complex task of audience targeting and campaign optimization. Advertisers benefit from a clearer understanding of their campaign's performance and actionable steps to enhance it, whether through refining audience segments, adjusting budgets, or experimenting with new ad formats. As the platform evolves, the campaign manager continues to refine its algorithms, ensuring that recommendations remain cutting-edge and aligned with the dynamic nature of digital advertising.

However, generating recommendations that cause an entity, such as a user (e.g., a marketing director) of an advertising company, to actually take a recommended action is technically challenging. This is due, at least in part, to a lack of awareness of the generative AI model used to generate the recommendation. The generative AI model is not trained to learn patterns of behavior of a given user when generating recommendations. For example, assume the campaign manager generates a recommendation to target a new audience in an awareness campaign to gain a +15% CTR. The recommendation provides a text description explaining that 42% of the members in a consideration phase are “Product Management” job function, compared to only 10% in the awareness step. The recommendation requests to update an awareness audience to drive more members down a conversion funnel. The recommendation has a CTA button to “Create Audience” and a “Dismiss” button to dismiss the recommendation. The recommendation is clear and specific, and yet the user does not select the CTA button. This occurs for any number of reasons. For example, the recommendation may not align with campaign goals set by the user. The user might instead be focused on increasing leads for conversion events, such as purchasing of products or services, as evidenced by past behavior. Since the generative AI model used to generate the recommendation does so in a vacuum, without learning preferences of a decision maker, the recommendations result in a low action rate.

Embodiments solve these and other technical challenges. Embodiments are generally directed to a connection network system. Some embodiments are particularly directed to artificial intelligence (AI) and machine learning (ML) techniques to support applications and/or services provided by a connection network system. For example, embodiments of the present disclosure comprise a content delivery system implementing one or more ML models, such as generative AI models like a large language model (LLM), to generate recommendations aligned with human preferences. The LLM is jointly trained with a reward model used for human preference modeling. The task objective of the LLM is to maximize a value derived from text generation, uniquely tailoring the optimization process to each entity (e.g., a user, a company) by leveraging contextual information, such as past behavior data, campaign performance data, and system data, among other types of data.

In some embodiments, for example, the LLM is trained using a Bradley-Terry model. The Bradley-Terry model is a statistical method used to rank items or entities based on pairwise comparisons, making it well-suited for training machine learning models with preference data, such as favored and disfavored responses. In the context of training an ML model, the model assigns a latent “strength” or quality score to each response, representing its relative preference. Given pairs of responses where one is favored over the other, the Bradley-Terry model estimates these scores by modeling the probability that one response is preferred over another. The probability that response A is favored over response B is expressed as P(A>B)=exp(θ_A)/(exp(θ_A)+exp(θ_B)), where θ_A and θ_B are the strength parameters for responses A and B, respectively. By maximizing the likelihood of observing the given preference pairs, the model iteratively adjusts these strength scores to reflect the relative quality of responses, which can then be used to fine-tune an ML model, such as in reinforcement learning with human feedback (RLHF).

In practice, the Bradley-Terry model is applied to preference datasets by constructing a loss function based on the log-likelihood of the observed favored-disfavored pairs. For each pair, the model computes the difference in strength scores (θ_favored−θ_disfavored) and uses it to predict the likelihood of the observed preference. During training, the ML model is optimized to increase the strength scores of favored responses relative to disfavored ones, effectively aligning the model's outputs with human preferences. This approach is particularly useful in applications like chatbot response ranking or recommendation systems, where the goal is to prioritize higher-quality outputs. However, the model assumes that preferences are consistent and transitive, which may not always hold in real-world data, requiring careful preprocessing to handle inconsistencies or noisy preference judgments.

Specifically, a training system implements an ML algorithm to jointly train a reward model and an LLM based on expected value associated with an entity. The ML algorithm uses a robust loss for the reward model training. The ML algorithm uses training samples with value outcomes from past actions taken by entities. In some cases, however, the value outcomes are often sparse. To mitigate this problem, the ML algorithm augments the reward feedback with group-level data, such as an expected value over a group or cohort. In addition, the ML algorithm uses cross-attention and retrieval-augmented generation (RAG) techniques to inject context in both the reward model and the LLM for text generation. This approach uses relevant information from past actions and internal system data, thereby ensuring context aware recommendations.

As an exemplary use case, the trained LLM generates recommendations or measurement insights that maximize value to an entity and/or the connection network system given entity data and historical activity data of the entity and their respective campaign performance.

Embodiments provide several technical solutions to multiple technical problems. For example, embodiments implement a model-based approach to solve the technical problem of traditional preference-based alignment. Extensive research has explored the alignment of LLMs for chatbots and AI agents through human preference modeling, often utilizing frameworks like the Bradley-Terry model, which employs pairwise comparisons of favored and disfavored responses to train LLMs to generate outputs that align with human expectations. However, embodiments propose a novel approach that shifts the focus to optimizing LLMs for business value by integrating a reward model trained on quantifiable customer actions and contextual data. Unlike traditional preference-based alignment, which relies on subjective human judgments, an AI framework aims to maximize measurable business outcomes, such as customer engagement, conversions, or revenue, by tailoring text generation to individual users or advertisers. The reward model leverages diverse data sources, including historical user behavior (e.g., purchases, browsing history, or campaign interactions), demographic or psychographic information (e.g., user preferences or segment-specific characteristics), and campaign metadata (e.g., budget, target audience, or key performance indicators). This approach ensures that LLM outputs are not only relevant but also optimized for specific, measurable business goals. Embodiments generate tailored recommendations or insights to maximize value for both the advertiser and the platform, based on the advertiser's historical campaign performance and user interactions. For instance, given data on past campaigns (e.g., budget, audience targeting, creative assets, and performance metrics like click-through rates or cost-per-click), user interactions (e.g., which users clicked on ads, their job titles, or industries), and advertiser preferences (e.g., prioritizing lead quality), a generative AI model is trained to produce outputs like optimized ad copy, audience segment refinements, or budget allocation strategies to enhance performance metrics such as CTR, CVR, and return on ad spend (ROAS). The reward model evaluates these recommendations by predicting their impact on key performance indicators, such as a 10% increase in click-through rates or a 15% reduction in cost-per-click, using patterns from historical data and real-time campaign feedback. This ensures that the generated insights deliver tangible business value rather than generic suggestions. Embodiments provide an AI framework that offers more precision by focusing on measurable outcomes, avoiding the ambiguity of subjective judgments, and enables personalization by tailoring outputs to individual users or advertisers, thereby increasing relevance and effectiveness. The AI framework is scalable across industries, from e-commerce to financial services, by adapting the reward model to specific KPIs, and it supports iterative improvement through real-time feedback from user actions and campaign performance. Embodiments ensure data quality and mitigating biases in user behavior logs, to avoid skewing predictions, and address multi-objective optimization by balancing competing goals like advertiser ROI and platform revenue. Other technical advantages exist as well.

The embodiments disclosed herein are only examples, and the scope of this disclosure is not limited to them. Specific embodiments may include all, some, or none of the components, elements, features, functions, operations, or steps of the embodiments disclosed above. Embodiments according to the invention are particularly disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particularly multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Detailed Embodiments

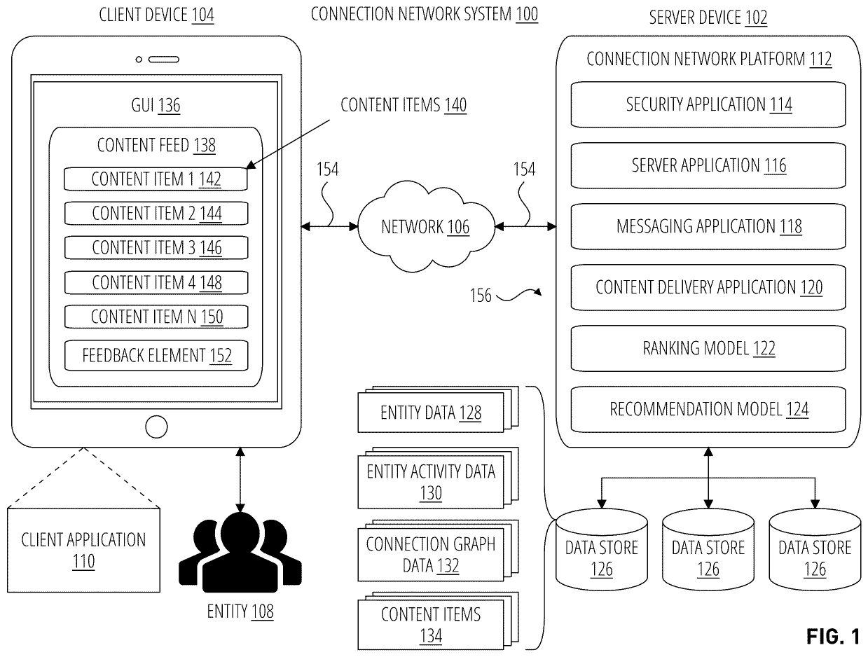

FIG. 1 illustrates a connection network system 100. The connection network system 100 is an example of an architecture or framework for an online computer and communications system designed to serve content items to an electronic device associated with a user. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. Additionally, or alternatively, the client device 104 may communicate with another client device 104 in a peer-to-peer (P2P) mode or via the server device 102. In operation, an entity 108 interacts with a client application 110 of the client device 104 to access applications and services provided by a connection network platform 112 of the server device 102. The connection network platform 112 offers a number of network services 156 for the connection network system 100, such as network services provided by a security application 114, a server application 116, a messaging application 118, a content delivery application 120, a ranking model 122, and/or a recommendation model 124. The server device 102 has access to one or more data stores 126. The data stores 126 store information for the connection network platform 112, such as entity data 128, entity activity data 130, connection graph data 132, and content items 134.

The connection network system 100 comprises a server device 102. In specific embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network entity 108 at a client device 104 via the network 106. A client device 104 may enable its entity 108 to communicate with other entities 108 at the server device 102, such as via messaging applications 118.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about a user's actions on or off the connection network platform 112. In conjunction with the action log, a third-party-content-object log may be maintained of user exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with users. Advertisement-pricing modules may combine connections information, the current time, location information, or other suitable information to provide relevant advertisements, in the form of notifications, to a user.

The connection network system 100 comprises a connection network platform 112. In particular embodiments, the connection network platform 112 may be part of a network addressable computing system that can host an online connection network. The connection network platform 112 may generate, store, receive, and send connection networking data, such as, for example, entity data 128 (e.g., user-profile data, concept-profile data, etc.), entity activity data 130 (e.g., user interactions with connection network platform 112), connection graph data 132 (e.g., connections between users or entities), content items 134, or other suitable data related to the online connection network. The connection network platform 112 may be accessed by the other components of the connection network system 100 either directly or via a network 106. As an example and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 comprises a security application 114. In particular embodiments, a security application 114 may be an application or electronic device including hardware, software, or embedded logic components or a combination of two or more such components and capable of carrying out the appropriate functionalities implemented or supported by the security application 114. The security application 114 is a network security system that encompasses a suite of technologies, policies, and practices designed to protect the integrity, confidentiality, and availability of data within the connection network platform 112 from unauthorized access, attacks, and other security threats. The security application 114 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 114 implements security practices to ensure a robust defense against a wide array of cyber threats, safeguarding organizational assets and maintaining trust with stakeholders.

The connection network platform 112 comprises a server application 116. In particular embodiments, the server application 116 may be a web server to serve content information, such as content items 134, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the entity 108.

In particular embodiments, the server application 116 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 116 may be an e-commerce application, a content application, an advertisement application, a web interface, a messaging application, a video application, a webpage, and so forth.

In particular embodiments, the server application 116 may be an application for managing various applications and services provided by the online connection network hosted on the connection network platform 112. In particular embodiments, the server application 116 may include hardware, software, or embedded logic components or a combination of two or more such components for carrying out the appropriate functionalities implemented or supported by connection network platform 112. Although the server device 102 is shown with a single server application 116, it should be noted that this is not by any way limiting and this disclosure contemplates any number of server applications 116.

The connection network platform 112 comprises a messaging application 118. The messaging application 118 is software that enables users to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 112 comprises a content delivery application 120. The content delivery application 120 is a software tool that allows users to efficiently deliver content items to other users of the connection network platform 112 of the connection network system 100, such as content items 134 stored by one or more data stores 126 or third-party content servers. An example for the content delivery application 120 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 120 allows advertisers to create, manage, and analyze their ad campaigns on the platform in accordance with a larger programmatic advertising strategy. It allows for precise targeting based on entity data 128 and/or entity activity data 130, making it especially useful for business-to-business (B2B) or business-to-consumer (B2C) marketing campaigns. The content delivery application 120 delivers content items 134, such as a series of one or more advertisements, to an audience of entities 108 of the connection network platform 112 of the connection network system 100. The content delivery application 120 assist advertisers in delivering content and ads to a professional audience by leveraging user profiles, job titles, industries, and other entity data 128 and entity activity data 130 collected by the connection network platform 112.

The connection network platform 112 comprises various machine learning (ML) models, such as a ranking model 122. A ranking model 122 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to users.

The connection network platform 112 comprises various ML models, such as a recommendation model 124. A recommendation model 124 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 102 comprises, or has access to, one or more data stores 126. In particular embodiments, the connections networking system 102 may include a data store 126. The data store 126 may be used to store various types of information for the server device 102 and/or the connection network platform 112. In particular embodiments, the information stored in the data store 126 may be organized according to specific data structures. In particular embodiments, the data store 126 may be a relational, columnar, correlation, or other suitable database. Although this disclosure describes or illustrates particular types of databases, this disclosure contemplates any suitable types of databases. Particular embodiments may provide interfaces that enable a client device 104 or a connection network system 100 to manage, retrieve, modify, add, or delete, the information stored in the data store 126.

In one embodiment, for example, the data store 126 stores entity data 128 for the connection network platform 112. In particular embodiments, the connection network platform 112 may include entity data 128 for various entities of the connection network platform 112. Non-limiting examples of entities may include users, individuals, members, businesses, companies, organizations, software agents, hardware agents, and so forth. For example, the entity data 128 may comprise one or more user profiles associated with users of the connection network platform 112. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 126 stores entity activity data 130 for the connection network platform 112. The entity activity data 130 represents various activities recorded for an entity 108 by the connection network platform 112. In particular embodiments, the connection network platform 112 may provide entities (e.g., users) with the ability to take actions on various types of items or objects supported (or accessible) by connection network platform 112. As an example and not by way of limitation, the items and objects may include groups or connections networks to which users of the connection network platform 112 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 112 or by an external system of a third-party system, which is separate from the server device 102 and coupled to the server device 102 via a network 106.

In one embodiment, for example, the data store 126 stores connection graph data 132 for the connection network platform 112. The connection network platform 112 may store connection graph data 132 for one or more users (e.g., members with subscription accounts) of the connection network platform 112. In one embodiment, for example, connection graph data 132 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 112 may provide users of the online connection network system 100 the ability to communicate and interact with other users. In particular embodiments, users may join the online connection network platform 112 via the connection network system 100 and then add connections (e.g., relationships) to a number of other users of the connection network platform 112 to whom they want to be connected. Herein, the term “connection” may refer to any other user of the connection network platform 112 or the connection network system 100 with whom a user has formed a friendship, association, or relationship via the connection network platform 112.

In one embodiment, for example, the data store 126 stores content items 134 for the connection network platform 112. The content items 134 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 112 also includes user-generated content (UGC) objects, which may enhance a user's interactions with the connection network platform 112. User-generated content may include anything a user can add, upload, send, message, or “post” to the connection network platform 112. As an example and not by way of limitation, a user communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network user at a client device 104 to access a network 106. A client device 104 may enable its entity 108 to communicate with other entities 108 at other client devices 104, such as via messaging application 118.

The connection network system 100 comprises a client application 110. In particular embodiments, a client device 104 may include a client application 110, which may be a web browser, and may have one or more add-ons, plug-ins, or other extensions. An entity 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the entity 108. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 118 for messaging with entities 108 of a messaging network or system, a web browser application, an internet searching application, and so forth.

In particular embodiments, the client application 110 may be storable in a memory and executable by a processor circuitry of the client device 104 to render user interfaces, receive user input, send data to and receive data from the connection network platform 112. The client application 110 may generate and present user interfaces to a user via an electronic display of the client device 104. For example, the client application 110 may generate and present a GUI 136 based at least in part on information received from the server device 102, the connection network platform 112, and/or another device or system (e.g., a third party server) via the network 106.

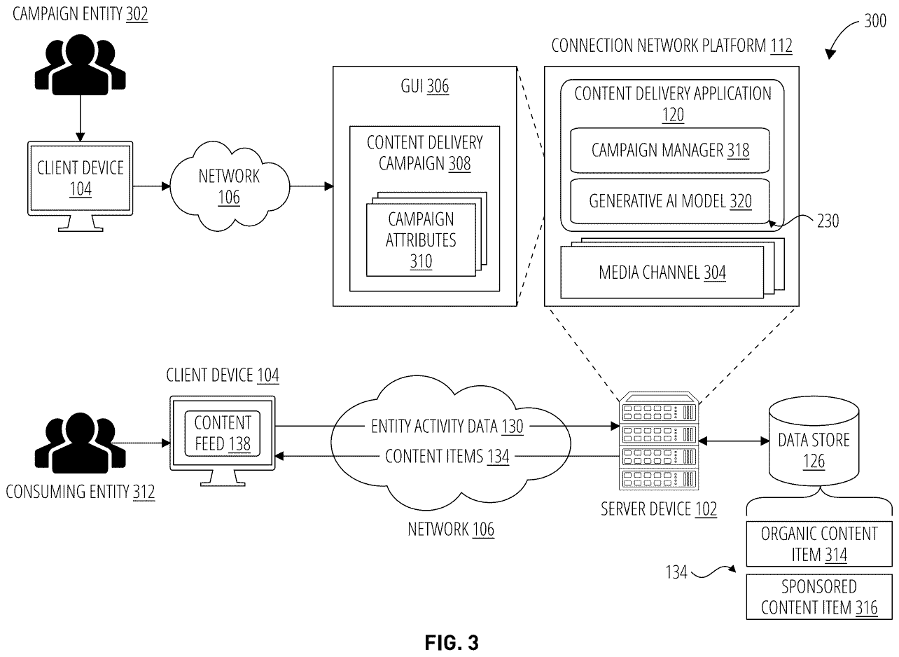

In some embodiments, the connection network platform 112 and/or the client application 110 and/or an operating system of the client device 104 may generate a GUI 136 on an electronic display of the client device 104. The client application 110 may receive one or more content items 134 from the data store 126 of the connection network platform 112 from the content delivery application 120. The client application 110 may display the content items 134 as content items 140 on a content feed 138 of the GUI 136. The content items 140 may include a feedback element 152 that when selected or activated by the entity 108, causes the GUI 136 to generate a signal such as a message for delivery to the content delivery application 120 of the connection network platform 112. The signal or message may comprise a feedback signal to the content delivery application 120 for use by the content delivery application 120 to select a new content item from the data store 126 for delivery to the client device 104. For example, the content delivery application 120 may use the feedback signal as part of an ML model to select content items 134 for a marketing campaign managed by the content delivery application 120, as described in more detail with reference to FIG. 3.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, an entity 108 interacts with a client application 110 of the client device 104 to access applications and services provided by a connection network platform 112 of the server device 102 via one or more links 154 of the network 106. The links 154 may connect each client device 104 to the connection network platform 112 via the network 106. This disclosure contemplates any suitable link 154. In particular embodiments, one or more links 154 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 154 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 154, or a combination of two or more such links 154. Links 154 need not necessarily operate at the same throughout. One or more first links 154 may differ in one or more respects from one or more second links 154.

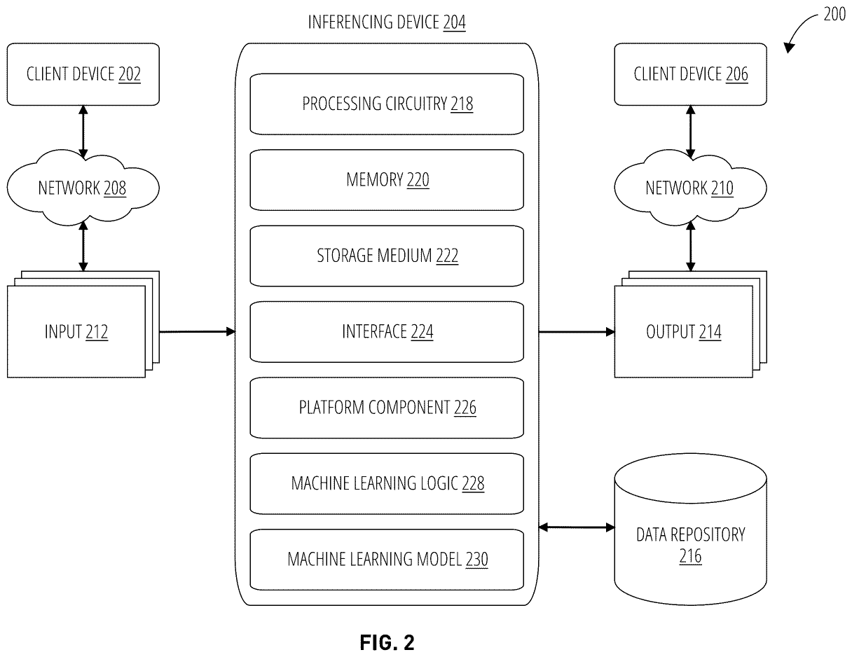

FIG. 2 illustrates an embodiment of a system 200. The system 200 is suitable for implementing one or more embodiments as described herein. In one embodiment, for example, the system 200 is an AI/ML system suitable for implementing models described with reference to any of the preceding description.

The system 200 comprises a set of M devices, where M is any positive integer. FIG. 2 depicts three devices (M=3), including a client device 202, an inferencing device 204, and a client device 206. The inferencing device 204 communicates information with the client device 202 and the client device 206 over a network 208 and a network 210, respectively. The information may include input 212 from the client device 202 and output 214 to the client device 206, or vice-versa. In one alternative, the input 212 and the output 214 are communicated between the same client device 202 or client device 206. In another alternative, the input 212 and the output 214 are stored in a data repository 216. In yet another alternative, the input 212 and the output 214 are communicated via a platform component 226 of the inferencing device 204, such as an input/output (I/O) device (e.g., a touchscreen, a microphone, a speaker, etc.).

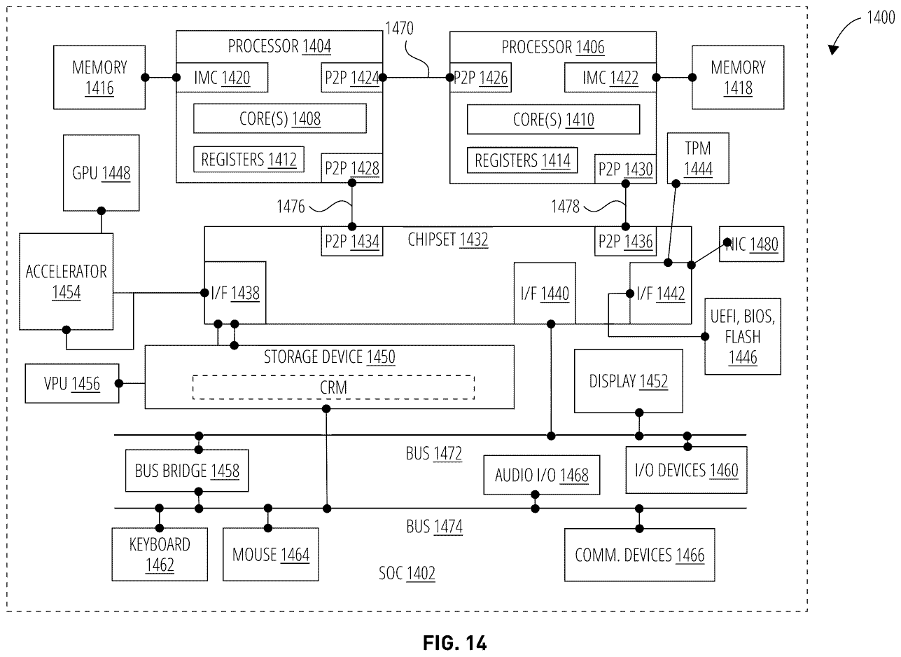

As depicted in FIG. 2, the inferencing device 204 includes processing circuitry 218, a memory 220, a storage medium 222, an interface 224, a platform component 226, ML logic 228, and an ML model 230. In some implementations, the inferencing device 204 includes other components or devices as well. Examples for software elements and hardware elements of the inferencing device 204 are described in more detail with reference to a computing architecture 1400 as depicted in FIG. 14. Embodiments are not limited to these examples.

The inferencing device 204 is generally arranged to receive an input 212, process the input 212 via one or more AI/ML techniques, and send an output 214. The inferencing device 204 receives the input 212 from the client device 202 via the network 208, the client device 206 via the network 210, the platform component 226 (e.g., a touchscreen as a text command or microphone as a voice command), the memory 220, the storage medium 222 or the data repository 216. The inferencing device 204 sends the output 214 to the client device 202 via the network 208, the client device 206 via the network 210, the platform component 226 (e.g., a touchscreen to present text, graphic or video information or speaker to reproduce audio information), the memory 220, the storage medium 222 or the data repository 216.

The inferencing device 204 includes ML logic 228 and an ML model 230 to implement various AI/ML techniques for various AI/ML tasks. The ML logic 228 receives the input 212, and processes the input 212 using the ML model 230. The ML model 230 performs inferencing operations to generate an inference for a specific task from the input 212. In some cases, the inference is part of the output 214. The output 214 is used by the client device 202, the inferencing device 204, or the client device 206 to perform subsequent actions in response to the output 214.

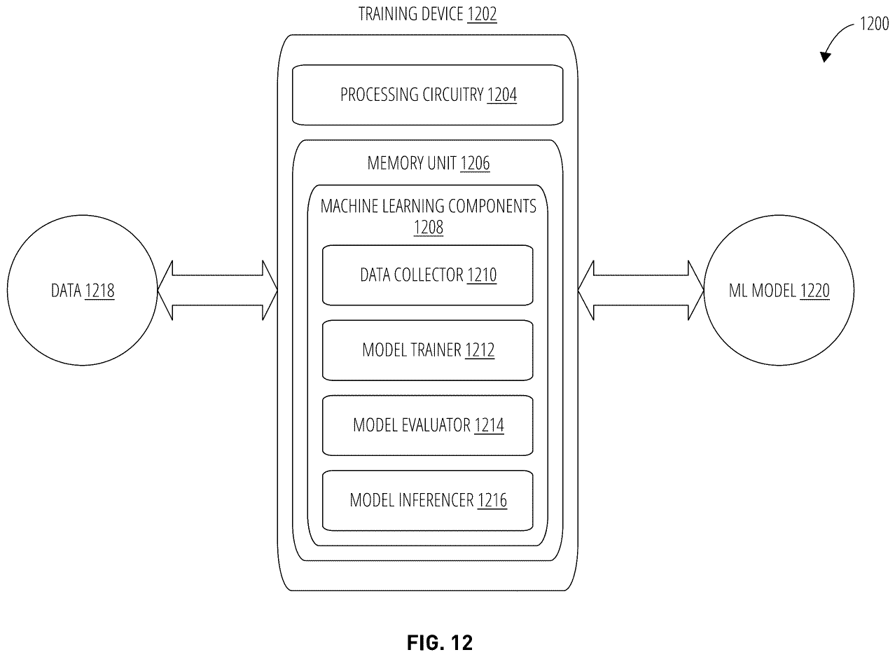

In various embodiments, the ML model 230 is a trained ML model 230 using a set of training operations. An example of training operations to train the ML model 230 is described with reference to FIG. 12.

FIG. 3 illustrates a content delivery system 300. The content delivery system 300 is an example of a system designed to deliver one or more content items 134 such as one or more organic content item 314 and/or sponsored content item 316 to a consuming entity 312 of the connection network platform 112 of the connection network system 100. The content delivery system 300 delivers the content items 134 in a targeted manner. The content items 134 may comprise, for example, recommendations, advertisements, content, messages, suggestions, hyperlinks, files, job postings, articles, and any other content offered by the connection network platform 112 of the connection network system 100.

In various embodiments, the connection network system 100 may use the content delivery system 300 to provide a content delivery service via a content delivery application 120 (e.g., software as a service (Saas)) to its entities 108 (e.g., individuals, members, entities, groups, etc.). The content delivery system 300 is generally designed to deliver electronic content items 134 to entities 108 based, at least in part, on entity data 128 and entity activity data 130 of entities 108 of the connection network system 100. In particular, the content delivery system 300 may deliver content items 134 such as organic content items 314 and/or sponsored content items 316 specifically targeted to an audience of entities 108 based on entity data 128 or entity activity data 130. For instance, a content producer such as an advertiser may create a content delivery campaign 308 such as a marketing campaign or advertising campaign to deliver a series of sponsored content items 316 for a product or service of a business entity to a consuming entity 312 of the connection network system 100 over a defined time interval (e.g., weeks, days, months, etc.). The content producer defines, controls, or manages the content delivery campaign 308 using a set of campaign attributes 310. The campaign attributes 310 may include various objectives of the content delivery campaign 308, such as increasing exposure, revenue, engagement, reach, and so forth.

The content delivery system 300 comprises a set of one or more client devices 104, server devices 102, and data stores 126. A client device 104 and a server device 102 may communicate information via a network 106. The client device 104 may comprise an electronic device, such as a smartwatch, smartphone, tablet, laptop computer, desktop computer, and so forth. The server device 102 may be implemented as a server in a data center, such as a cloud computing system or edge computing system. The client device 104 and the server device 102 may be implemented using an architecture as described in FIG. 14.

The server device 102 implements a connection network platform 112 as described with reference to FIG. 1. In one embodiment, the connection network platform 112 includes at least one processor circuitry, at least one memory unit operably coupled to the processor circuitry, the memory unit including instructions executable by the at least one processor circuitry, and an ML model 230 comprising parameters and/or hyperparameters stored in the at least one memory unit. In one embodiment, for example, the ML model 230 is implemented as a two-tower ML model for an AI system implemented by the content delivery system 300 to offer a network service such as a content delivery service by the content delivery application 120 of the connection network platform 112. The content delivery application 120 may select one or more content items 134, such as organic content items 314 and/or organic content items 314, for delivery as targeted content over one or more media channels 304 to a client device 104. A GUI 136 may present the content items 134 in a content feed 138 on the client device 104. An entity 108 from the consuming entity 312 may interact with a GUI element of the GUI 136 to access the targeted content, such as scrolling through the content feed 138 in an X, Y or Z dimension to view the content items 134, clicking on an organic content item 314 or sponsored content item 316 for further inspection, providing feedback using a feedback element 152, and other activities.

The server device 102 may include connection network platform 112 implementing a network service to entity 108 of the connection network platform 112. Professional networking platforms offer a wide range of networking services to facilitate connections, career development, and knowledge sharing. Some examples of a network service offered by the connection network platform 112 include without limitation: (1) users can create a professional profile to showcase their skills, work experience, education, and professional accomplishments; (2) users can connect with colleagues, industry professionals, and potential employers to expand their professional network; (3) messaging capabilities for direct communication between users, facilitating professional conversations and networking opportunities; (4) users can join and participate in industry-specific groups and communities to engage in discussions, share insights, and network with like-minded professionals; (5) search job listings and recruiting tools for users to search for employment opportunities, apply for jobs, and connect with talent; (6) users can share industry-related content, articles, and professional updates to showcase expertise and engage with their network; and (7) access learning resources, courses, and training programs to support ongoing professional development and skill enhancement. These networking services are designed to help professionals connect, collaborate, and grow their careers. Embodiments are not limited to these examples.

In an example process, the connection network platform 112 obtains entity activity data 130 from entities 108 via the client device 104. The entities 108 interact with the connection network platform 112 via a user interface of the connection network platform 112. In some cases, portions of the user interface are displayed on a personal machine or client device 104 of an entity 108. The entity activity data 130 represents various actions, activities or behaviors of one or more entities 108 of the consuming entity 312. For example, entity activity data 130 may represent data collected as the entities 108 interact with various content items 134, such as content items 134, of the data store 126 served via the server device 102. In another example, the entity activity data 130 may represent data collected as the entities 108 interact with other products or services offered by the connection network platform 112, such as searching for job postings, sending messages to entities 108, recommending posts by entities 108, sending and responding to connection requests, playing online games, and other activities organic to use of the connection network platform 112. Session data is any entity activity data 130 collected during a defined session time window, such as activity of the user over a 24 hour period or some other time interval. For example, an entity 108 of the consuming entity 312 may interact with the client device 104 to communicate with the connection network platform 112 of one or more of the server devices 102 to access one or more content items 134 stored by the data store 126. The entities 108 may perform various activities, such as browsing a web site, searching for a job posting, reading content, watching a streaming video, messaging other members, clicking on an GUI item, interacting with an advertisements, or engaging in electronic commerce. The session data, including the entity activity data 130, is transferred between the client device 104 and the server device 102.

More particularly, the connection network platform 112 comprises the content delivery application 120, which includes or accesses an ML model 230, and data for one or more media channels 304. In these particular embodiments, the content delivery system 300 uses multiple ML models 230 to support various downstream tasks for the content delivery application 120. One example of an ML model 230 is a generative AI model 320 using one or more MMOE and associated gates, as described further herein. Embodiments are not limited to these examples of ML model 230.

The content delivery application 120 is responsible for delivery of targeted content based on entity activity data 130 and/or session data associated with the entities 108 of the consuming entity 312. The content delivery application 120 uses the multiple ML models 230 to support such activities. The content delivery application 120 then targets delivery of specific content items 134 to users within user segments, such as organic content items 314 and/or sponsored content items 316 for the consuming entity 312, over one or more media channels 304 for presentation on the content feed 138 of the GUI 136. The targeted content is a content item that is relevant to the consuming entity 312 or the consuming entity 312 segment, such as messages, predictions, recommendations, advertisements, or suggestions to improve user experience.

The content delivery application 120 may include a campaign manager 318. The campaign manager 318 manages the content delivery campaign 308 and campaign attributes 310. For example, the campaign manager 318 may include a reporting function that receives metrics from the ML model 230. Examples of metrics may include inflation values or deflation values associated with member-based attributed events estimated using privacy-safe or privacy-constrained group-level data. The campaign entity 302 and/or the campaign manager 318 may modify the campaign attributes 310 based on the received metrics.

The targeted content is delivered through one or more of the media channels 304. A media channel refers to a specific platform or medium through which targeted content, such as advertisements, are disseminated to a target user. Media channels 304 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. message provider, such as advertisers, often choose certain media channels based on factors such as user engagement, reach, cost, and the compatibility of the channel with their target market. An example of the media channel 304 is a social media platform or a professional media platform, or some other mode of information transfer within the platform.

The connection network platform 112 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

The data store 126 is an organized collection of data. For example, the data store 126 stores data in a specified format known as a schema. The data store 126 can be structured as a single database, a distributed database, multiple distributed databases, or an emergency backup database. In some cases, a database controller manages data storage and processing in data store 126. In some cases, a user interacts with the database controller. In other cases, the database controller operates automatically without user interaction. The data store 126 is configured to store various content items 134. The content items 134 include any multimedia information suitable for presentation by the client device 104, such as HTML code to present websites, text, images, video, messages, advertisements, and so forth. In addition, the data store 126 may also store application data comprising information and data used by the connection network platform 112. For example, data store 126 is configured to store user session data, profiles, embeddings, budgets, cached application programming interface (API) requests, machine learning model parameters, training data, and other data.

Network 106 facilitates the transfer of information between connection network platform 112, data store 126, and client device 104. Network 106 is a computer network configured to provide on-demand availability of computer system resources, such as data storage and computing power. In some examples, the network 106 provides resources without active management by the entities 108. The network 106 includes data centers available to many users over the Internet. Some large cloud networks have functions distributed over multiple locations from central servers. A server is designated an edge server if it has a direct or close connection to an entities 108. In some cases, a cloud is limited to a single organization. In other examples, the cloud is available to many organizations. In one example, the network 106 includes a multi-layer communications network comprising multiple edge routers and core routers. In another example, the network 106 is based on a local collection of switches in a single physical location.

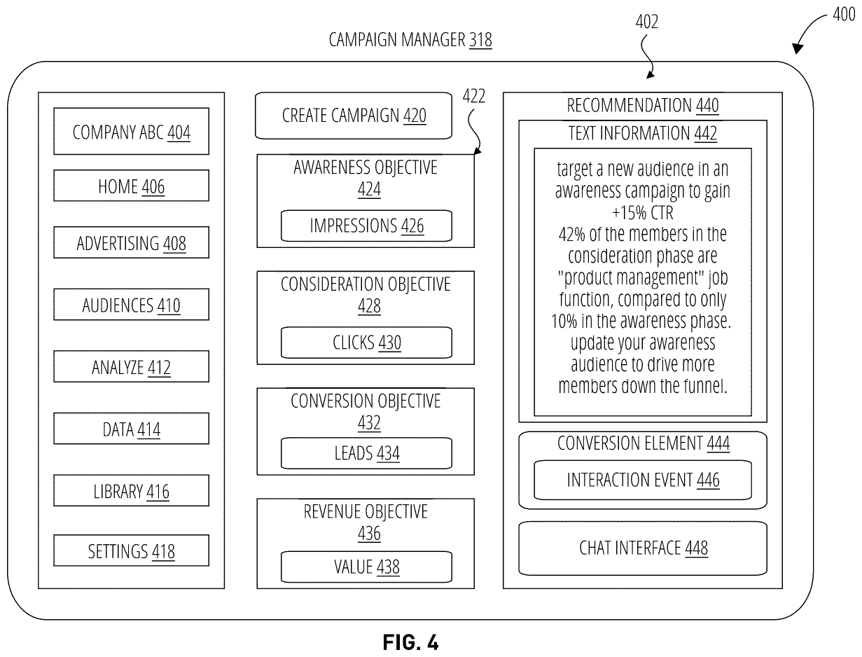

FIG. 4 illustrates a GUI view 400. The GUI view 400 is an example of GUI elements suitable for presentation on the GUI 306 of a campaign manager 318 on the client device 104 for a campaign entity 302. Embodiments are not limited to this example.

As depicted in FIG. 4 the campaign manager 318 generates a GUI view 400 on the GUI 306. The GUI view 400 is composed of different GUI elements 402 including GUI element 404 through GUI element 436. On a left side of the GUI view 400 is a set of GUI elements 402, such as GUI element 404, GUI element 406, GUI element 408, GUI element 410, GUI element 412, GUI element 414, GUI element 416, and GUI element 418 representing a text box to present information or functions such as company name, home screen, advertising services, analysis services, data services, library functions and settings, respectively. In the center of the GUI view 400 is a set of GUI elements 402, including a create campaign 420 to create a content delivery campaign 308 according to a set of campaign attributes 310. Further, the GUI view 400 includes a set of GUI elements 402 presenting various types of objectives for the content delivery campaign 308, such as an awareness objective, a consideration objective, a conversion objective, and a revenue objective presented by GUI element 424, GUI element 428, GUI element 432, and GUI element 436, respectively. Progress of a campaign objective is measured using performance metrics 422, such as an impressions 426 for the awareness objective, clicks 430 for the consideration objective, leads 434 for the conversion objective, and value 438 for the revenue objective. On the right side of the GUI view 400 is a set of GUI elements 402, including a recommendation 440 and text information 442 for the recommendation 440. In some embodiments, the generative AI model 320 generates the text information 442 for the recommendation 440. These are merely some examples of GUI elements 402, and the GUI view 400 may include other GUI elements 402 as well, such as performance charts, time series data, and other information suitable for presentation by the campaign manager 318. Embodiments are not limited to these examples.

The generative AI model 320 is designed to produce text information 442 in paragraph form, leveraging advanced natural language processing techniques. Non-limiting examples of generative AI models 320 include: (1) Generative Pre-trained Transformer (GPT) from the Generative Pre-trained Transformer (GPT) series, including GPT-3 and GPT-4; (2) Bidirectional Encoder Representations from Transformers (BERT) primarily designed for understanding text; (3) Bidirectional Encoder Representations from Transformers (BERT) adapted for text generation tasks; (4) Text-to-Text Transfer Transformer (T5) that frames all natural language processing tasks as text-to-text problems to generate well-structured paragraphs for summarization, translation, or question-answering by converting input prompts into coherent output text; (5) Large Language Model Meta AI (LLaMA) family, including LLaMA-2 and LLaMA-3, which are optimized for research purposes and capable of generating high-quality text; (6) Grok which is designed to provide helpful and truthful answers in paragraph form; (7) Conversational Language Understanding and Expression (CLUE) to generate paragraph-length responses for dialogue or narrative tasks prioritizing conversational coherence and often embedded in chatbot frameworks; and (8) Pathways Language Model (PaLM) for generating long-form text, including paragraphs for creative writing, explanations, or technical documentation.

Specifically, the generative AI model 320 generates text information 442 presented in a natural language to mimic human writing capable of understanding by the campaign entity 302. For example, the generative AI model 320 may analyze input data associated with the content delivery campaign 308 and/or the campaign entity 302 to detect patterns. Examples of input data may include campaign objectives for the content delivery campaign 308, the performance metrics 422 for the campaign objectives, entity data 128 for the campaign entity 302, and/or entity activity data 130 for the campaign entity 302. The generative AI model 320 may then generate the text information 442 for the recommendation 440 based on the patterns found by the analysis.

For example, assume the campaign manager 318 generates a recommendation 440 to target a new audience in an awareness campaign to gain a +15% CTR. The recommendation 440 provides a text description explaining that 42% of the members in a consideration phase are “Product Management” job function, compared to only 10% in the awareness step. The recommendation 440 requests to update an awareness audience to drive more members down a conversion funnel. The recommendation 440 has a conversion element 444 to “Create Audience” and/or other GUI elements, such as a “Dismiss” button to dismiss the recommendation 440.

The campaign manager 318 may also provide a chat interface 448. The chat interface 448 allows interaction between the campaign entity 302 and the generative AI model 320. For example, the campaign entity 302 may enter a query into the chat interface 448 for natural language processing by the generative AI model 320 to provide additional information about the recommendation 440 or provide an alternate recommendation 440 in an interactive manner.

In some embodiments in particular, the generative AI model 320 is trained to detect patterns in the input data and generate a recommendation 440 that is consistent with historical entity data 128 and entity activity data 130 of the campaign entity 302. For example, the generative AI model 320 is trained using a reward model based on value outcomes of a recommendation 440. Further, the generative AI model 320 is trained using a robust loss function for the reward model. In some cases, where value outcomes from actions taken by entities is sparse, entity-level data may be augmented with an expected value over a group based on group preferences. In addition, the generative AI model 320 leverages cross-attention models and retrieval-augmented generation (RAG) models to inject context in both the reward model and the generative AI model 320 for generating the text information 442. This approach injects relevant information from past actions and other types of stored data by the connection network system 100, thereby ensuring context-aware outputs.

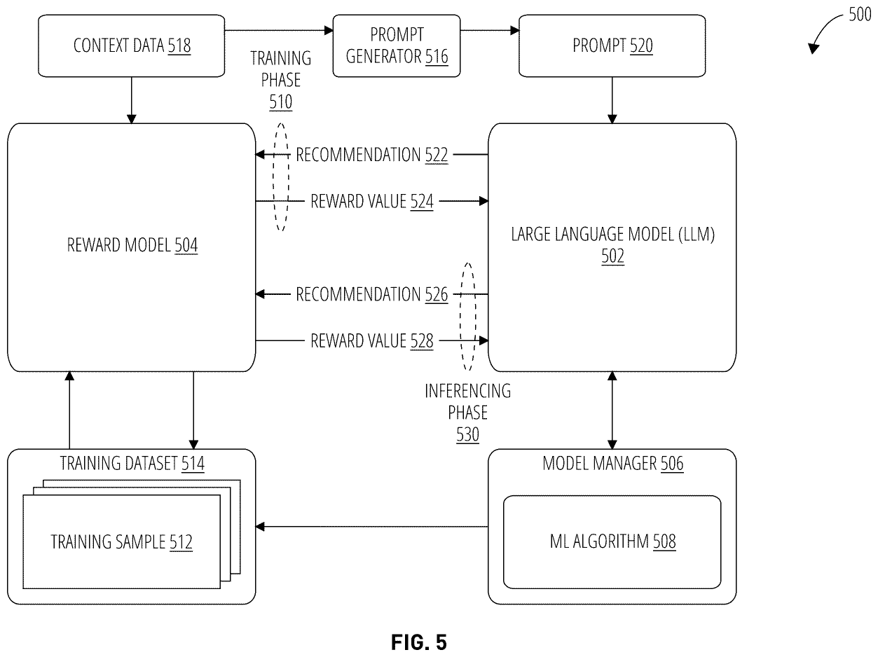

FIG. 5 illustrates a model architecture 500. The model architecture 500 is an example architecture for an ML model 230 used to generate recommendations 440 for the campaign manager 318. Embodiments are not limited to this example.

Extensive research has explored the alignment of LLMs for chatbots and AI agents through human preference modeling, often utilizing frameworks like the Bradley-Terry model, which employs pairwise comparisons of favored and disfavored responses to train LLMs to generate outputs that align with human expectations. However, embodiments propose a novel approach that shifts the focus to optimizing LLMs for business value by integrating a reward model 504 trained on quantifiable customer actions and contextual data. Unlike traditional preference-based alignment, which relies on subjective human judgments, this framework aims to maximize measurable business outcomes, such as customer engagement, conversions, or revenue, by tailoring text generation to individual users or advertisers. The reward model 504 leverages diverse data sources, including historical user behavior (e.g., purchases, browsing history, or campaign interactions), demographic or psychographic information (e.g., user preferences or segment-specific characteristics), and campaign metadata (e.g., budget, target audience, or key performance indicators). This approach ensures that LLM outputs are not only relevant but also optimized for specific, measurable business goals.

A practical example of this framework is its application in personalized recommendations 440, as depicted in GUI view 400 of GUI 306 described with reference to FIG. 4. In this scenario, the LLM 502 generates tailored recommendations or insights to maximize value for both the advertiser and the platform, based on the advertiser's historical campaign performance and user interactions. For instance, given data on past campaigns (e.g., budget, audience targeting, creative assets, and performance metrics like click-through rates or cost-per-click), user interactions (e.g., which users clicked on ads, their job titles, or industries), and advertiser preferences (e.g., prioritizing lead quality), the LLM 502 produces outputs like optimized ad copy, audience segment refinements, or budget allocation strategies to enhance return on ad spend (ROAS). The reward model 504 evaluates these recommendations by predicting their impact on key performance indicators, such as a 10% increase in click-through rates or a 15% reduction in cost-per-click, using patterns from historical data and real-time campaign feedback. This ensures that the generated insights deliver tangible business value rather than generic suggestions.

The technical implementation of this framework involves several integrated components. Data collection and preprocessing are important, requiring the aggregation and cleaning of user actions, campaign performance, and contextual metadata, followed by normalization to ensure compatibility with the reward model 504 and LLM 502. The reward model 504 is trained using supervised learning to estimate the business value of LLM outputs, such as predicting expected conversion rates based on historical data, and may incorporate reinforcement learning techniques like Proximal Policy Optimization (PPO) to fine-tune the LLM 502 based on feedback from the reward model 504. Multi-task learning can also be employed to optimize for multiple objectives, such as balancing advertiser ROI and platform revenue. The LLM 502 is fine-tuned to prioritize high-value responses, potentially using contrastive learning to distinguish between high-and low-value outputs. Contextual personalization is achieved by conditioning LLM outputs on user or advertiser data through embeddings or dynamic prompting, enabling adaptive behavior for specific users or campaigns. Continuous evaluation using real-world outcomes, such as actual campaign results, allows for iterative updates to both the reward model 504 and LLM 502 to maintain alignment with evolving business goals.

As depicted in FIG. 5, the model architecture 500 comprises a generative AI model 320, such as an LLM 502. The LLM 502 is designed to generate text information 442 for a recommendation 440, such as recommendation 522 during a training phase 510 and recommendation 526 during an inferencing phase 530. The LLM 502 is a neural network trained on vast datasets of text, enabling it to understand and generate human-like language for tasks such as generating recommendations. When tasked with producing a recommendation 440, the LLM 502 processes input data-such as user preferences, campaign metrics, or contextual details-through its layers of interconnected nodes, which encode patterns and relationships from its training data. Using this input, the LLM 502 predicts the most likely sequence of words to form a coherent and relevant recommendation, such as suggesting a change in campaign attributes 310 for a content delivery campaign 308 based on performance metrics 422. By leveraging its understanding of language and context, the LLM 502 generates tailored, data-driven recommendations that align with the input, often refining its output through techniques like beam search or sampling to ensure clarity and relevance.

The model architecture 500 further comprises a reward model 504. The reward model 504 is designed to analyze recommendations 440 and generate reward values for recommendations 440, such as reward value 524 during a training phase 510 and reward value 528 during an inferencing phase 530. The reward model 504 for the LLM is designed to assign numerical reward values to recommendations 440, guiding its optimization toward generating high-quality outputs. In some embodiments, the reward model 504 is implemented as a human preference-based model, such as the Bradley-Terry model, which ranks recommendations based on pairwise comparisons of favored versus disfavored outputs, assigning higher rewards to preferred responses. In some embodiments, the reward model 504 is implemented as a rule-based reward model that evaluates recommendations against predefined criteria, such as relevance or clarity, using metrics like keyword alignment or sentiment scores. In some embodiments, the reward model 504 is implemented as a learned reward model that is trained on human feedback or datasets like Reinforcement Learning from Human Feedback (RLHF) and predict rewards by modeling complex patterns in high-quality recommendations. In some embodiments, the reward model 504 is implemented as a hybrid model that combines these approaches, integrating human preferences with rule-based metrics for robustness. Each model type balances trade-offs between scalability, subjectivity, and precision, with the choice depending on the application and available feedback data.

In some embodiments, the reward model 504 is implemented as a human preference-based reward model for the LLM. The reward model 504 evaluates the quality of generated recommendations 440 by assigning reward values based on human judgments of preference, typically collected through pairwise comparisons, such as from past actions of a campaign entity 302 or group of campaign entities 302. In this approach, the past actions are from campaign entities 302 that compare pairs of LLM-generated recommendations, and through activation of conversion elements, labeling one as favored and the other as disfavored based on criteria like relevance, clarity, or alignment with user intent. The reward model 504 is built using frameworks like the Bradley-Terry model, assigns latent quality scores to each recommendation 440, estimating the probability that one is preferred over another. By training on these preference pairs, the reward model 504 learns to predict higher reward values for recommendations 440 that align with human preferences, enabling the LLM to optimize its outputs during fine-tuning, such as in reinforcement learning with human feedback (RLHF). This method excels in capturing subjective quality but relies heavily on the consistency and scale of human feedback as expressed by past actions and behavior of the campaign entity 302, which is sometimes sparse data. Therefore, in some embodiments, the ML algorithm 508 trains the reward model 504 using entity-level or group-level data for campaign entities 302 of the connection network system 100.

During a training phase 510, a model manager 506 executes an ML algorithm 508 to jointly train the LLM 502 and the reward model 504. The ML algorithm 508 selects a training sample 512 from a training dataset 514. The training sample 512 comprises entity data 128 and entity activity data 130 associated with a campaign entity 302. The entity activity data 130 comprises historical data of past actions taken by the campaign entity 302 in response to past recommendations 440, such as selecting a conversion element 444. In some cases, when the entity activity data 130 for the campaign entity 302 is sparse, the training sample 512 comprises an aggregated value representing past actions taken by a group of campaign entities 302 in response to past recommendations 440 similar to a given recommendation 440 for the campaign entity 302. For example, the aggregated value may comprise a percentage value for past actions, such as 60%, 80%, etc.

The training process for the LLM 502 and the reward model 504 begins with the curation and preprocessing of a diverse training dataset 514 comprising training samples 512 with past recommendations, user actions from marketing managers, and system data from the content delivery system 300. The training dataset 514 includes historical campaign performance metrics 422 (e.g., click-through rates, conversion rates), user interactions (e.g., accepted or rejected recommendations), and platform-specific data (e.g., audience demographics, content types, delivery schedules). These training samples 512 are cleaned, normalized, and structured to ensure compatibility with the models. The LLM 502 is initialized with a pre-trained base model, fine-tuned on this training dataset 514 to generate contextually relevant recommendations 440, while the reward model 504 is designed to predict the effectiveness of these recommendations 440 based on historical outcomes. Both models are trained jointly in an iterative framework, where the LLM 502 generates recommendations 440, and the reward model 504 evaluates them, providing feedback to refine outputs of the LLM 502.

The reward model 504 is a supervised learning system designed to evaluate the effectiveness of recommendations 440 generated by the LLM 502 for optimizing content delivery campaigns 308, providing a feedback mechanism within the joint training framework. It is trained on an extensive dataset comprising historical recommendations, detailed user actions from marketing managers (e.g., accepting, modifying, or rejecting suggestions), and comprehensive campaign performance metrics, such as click-through rates, conversion rates, cost-per-acquisition, and audience engagement scores. Additional system data from the content delivery system 300, including audience demographics, behavioral segmentation, content metadata (e.g., format, length, tone), and delivery parameters (e.g., timing, channel), are incorporated to enrich model context. The reward model 504 employs a deep neural network architecture, typically a transformer or gradient-boosted decision tree ensemble, to learn complex patterns that correlate specific recommendation features with successful campaign outcomes. It outputs a scalar reward score for each LLM-generated recommendation, reflecting its predicted impact on campaign KPIs, with higher scores indicating recommendations likely to replicate or exceed past successes. To ensure robustness, the model is regularized to prevent overfitting and is periodically retrained with fresh user feedback and real-time platform data, enabling it to adapt to shifting market trends and user preferences. Techniques like feature importance analysis and uncertainty quantification are applied to enhance interpretability and reliability, ensuring the reward model 504 provides precise, actionable feedback to guide LLM optimization within a Proximal Policy Optimization (PPO) framework. This dynamic adaptability and granular evaluation capability causes the reward model 504 to improve the capability of the LLM 502 to generate high-impact, contextually relevant recommendations.

In some embodiments, the joint training process leverages a reinforcement learning (RL) approach, specifically a variant of PPO, to optimize recommendation generation by the LLM 502. The LLM 502 generates a set of candidate recommendations 526 for a given campaign context represented by the context data 518, and the reward model 504 assigns a reward value 528 (e.g., a score) based on learned patterns from successful past campaigns and user actions. This score reflects the predicted impact on key performance indicators (KPIs) like engagement or conversions. The reward model 504 is trained on historical data, where ground truth labels are derived from actual campaign outcomes and user decisions (e.g., implementing a recommendation that led to a 10% uplift in conversions). A policy for the LLM 502 is updated to maximize the expected reward, balancing exploration of new recommendation strategies with exploitation of known successful patterns. Regular evaluation on a held-out validation set ensures the models generalize to unseen campaign scenarios.

The RL approach using PPO optimizes recommendation generation by treating the recommendation task as a sequential decision-making problem. In this setup, the LLM 502 acts as the policy, generating recommendations 440 based on the current campaign context data 518, while the reward model 504 evaluates these recommendations 440 by assigning a score reflecting their predicted impact on campaign KPIs, such as click-through or conversion rates. PPO, a policy gradient method, balances exploration and exploitation by iteratively updating LLM parameters to maximize the expected reward while constraining policy updates to prevent instability. Specifically, PPO uses a clipped objective function to limit the magnitude of policy changes, ensuring stable learning by avoiding overly aggressive updates that could degrade performance. The reward model 504, trained on historical campaign outcomes and user actions, provides feedback to guide the LLM 502 toward generating recommendations 440 that align with successful patterns, with the process iterating until the LLM 502 converges on a policy that consistently produces high-impact recommendations 440.

To enhance robustness and adaptability, the training process incorporates active learning and periodic retraining. As campaign entities 302 (e.g., marketing managers) interact with the system, their feedback (e.g., accepting, modifying, or rejecting recommendations) is integrated into the dataset, allowing the models to adapt to evolving user preferences and market trends. System data, such as real-time campaign performance or changes in audience behavior, is also fed back to update the understanding of the reward model 504 of success criteria. Techniques like data augmentation and simulated user actions are employed to address sparse or imbalanced data, such as using cohort or group-level data, thereby ensuring the LLM 502 generates diverse and actionable recommendations. The iterative nature of this process, combined with continuous monitoring for model drift, ensures the system remains aligned with the dynamic needs of content delivery campaigns.

For example, during a training phase 510, in a first training iteration, a prompt generator 516 receives as input entity data 128 and entity activity data 130 for a campaign entity 302. The prompt generator 516 also receives as input context data 518. The context data 518 comprises, for example, a content delivery campaign 308, a set of campaign attributes 310 for the content delivery campaign 308, and a set of performance metrics 422 representing campaign performance for the content delivery campaign 308 as described with reference to FIG. 4. The LLM 502 generates a recommendation 522 in response to a prompt 520. The prompt 520 comprises instructions for the LLM 502 to generate a recommendation 522 for the campaign entity 302 based on the entity data 128, the entity activity data 130, and the context data 518. The reward model 504 receives the recommendation 522, analyzes the recommendation 522 against the context data 518, and it generates a reward value 524 for the recommendation 522. The reward model 504 outputs the reward value 524 to the LLM 502. The LLM 502 uses the reward value 524 for fine-tuning operations for the LLM 502. The ML algorithm 508 repeats the training operations for a second training iteration, a third training iteration, and N training iterations, until all the training samples 512 for the training dataset 514 are processed, thereby completing an epoch. In some cases, the ML algorithm 508 trains the LLM 502 and reward model 504 using batches of training samples 512 (e.g., 32 samples, 64 samples, etc.). The ML algorithm 508 rearranges a sequence of the training samples 512, such as using a randomization algorithm, and processes the training samples 512 again for an M number of epochs as set by a hyperparameter. Additionally, or alternatively, the ML algorithm 508 terminates training operations when the LLM 502 converges on an optimal output.

Once the LLM 502 and reward model 504 are trained, the model manager 506 deploys the trained models to an inferencing device of the content delivery system 300 to perform inferencing operations. In the inferencing phase 530, the LLM 502 generates a set of recommendations 526 and the reward model 504 generates a set of reward values 528 for the set of recommendations 526. The LLM 502 (or the reward model 504) outputs the recommendations 526 and reward values 528 to a ranking model 122 to rank the recommendations 526, based at least in part, on the reward values 528. Then a recommendation model 124 receives a top K recommendations ranked by the ranking model 122, and it selects a final recommendation 526 for presentation on the GUI 306 as part of GUI view 400.

In some embodiments, during the training phase 510, the ML algorithm 508 trains (and retrains) the LLM 502 and reward model 504 using an offline execution pipeline. The offline execution pipeline includes components for data collection of training samples 512 of the training dataset 514 from various data sources. The offline execution pipeline also includes components for executing the ML algorithm 508 for performing a set of training iterations to jointly train the LLM 502 and reward model 504. In some embodiments, for example, the ML algorithm 508 trains the LLM 502 and the reward model 504 in parallel using parallel processing techniques, such as multiple processing threads of a CPU, GPU, or a combination of a CPU and a GPU.

In some embodiments, during the inferencing phase 530, the trained LLM 502 and trained reward model 504 are deployed as ML models 230 for the connection network system 100, system 200, or content delivery system 300, using an online execution pipeline. The online execution pipeline includes components for executing the LLM 502 and/or the reward model 504 for inferencing operations during the inferencing phase 530. In some embodiments, the online execution pipeline executes the LLM 502 and/or the reward model 504 to receive input data and generate output data in accordance with a set of latency constraints, such as delivering the output data in real-time or near-real time intervals, where real-time intervals are measured in milliseconds and near-real time intervals are measured in seconds. In some embodiments, for example, the LLM 502 and the reward model 504 perform inferencing operations in parallel using parallel processing techniques, such as multiple processing threads of a CPU, GPU, or a combination of a CPU and a GPU.

During the inferencing phase 530, a prompt generator 516 receives context data 518 comprising a set of performance metrics 422 for a content delivery campaign 308 associated with an entity identifier representing a campaign entity 302. The prompt generator 516 is a stand-alone component or integrated with the model manager 506. The set of performance metrics 422 include an impression value, a click-through-rate (CTR) value, a conversion rate (CVR) value, or a qualified lead (QL) value. The prompt generator 516 sends a prompt 520 to a generative AI model 320, such as LLM 502. The prompt 520 comprises the set of performance metrics 422 and instructions for the generative AI model 320 to generate a recommendation 526 based on the set of performance metrics 422. The recommendation 526 comprises digital content information, such as text information 442, and a conversion element 444 for a GUI view 400 of a GUI 306. The generative AI model 320, such as the LLM 502, generates the recommendation 526 and it is output to the reward model 504. The reward model 504 generates a reward value 528 for the recommendation 526. The reward value 528 indicates whether the digital content information, such as text information 442, of the recommendation 526 will cause the conversion element 444 to generate an interaction event 446 associated with the entity identifier. For example, the conversion element 444 is a GUI element from a set of GUI elements 402 of the GUI view 400 that when activated by an input device generates the interaction event 446. The LLM 502 receives the reward value 528 for the recommendation 526 from the reward model 504. The model manager 506 (or the ranking model 122 or recommendation model 124) determines whether to select the recommendation 526 for presentation on the GUI view 400 of the GUI 306 based on the reward value 528. The model manager 506 causes presentation of the selected recommendation 526 on the GUI view 400 of the GUI 306.

When the campaign entity 302 provides feedback by activating the conversion element 444, such as clicking on the conversion element 444 with an input device or touching a touchscreen interface of an electronic display of an electronic device, the conversion element 444 generates a signal for an interaction event 446 indicating the campaign entity 302 has interacted with the conversion element 444. Among other components of the connection network platform 112, the model manager 506 receives the interaction event 446 indicating activation of the conversion element 444, and it updates a training dataset 514 for the reward model 504 to include the interaction event 446 as a training sample 512. After a target number of new training samples 512 are collected, or after a defined time period has past (e.g., days, weeks, months), the model manager 506 causes execution of the ML algorithm 508 to train (or retrain) the reward model 504 using the new training samples 512 of the training dataset 514.

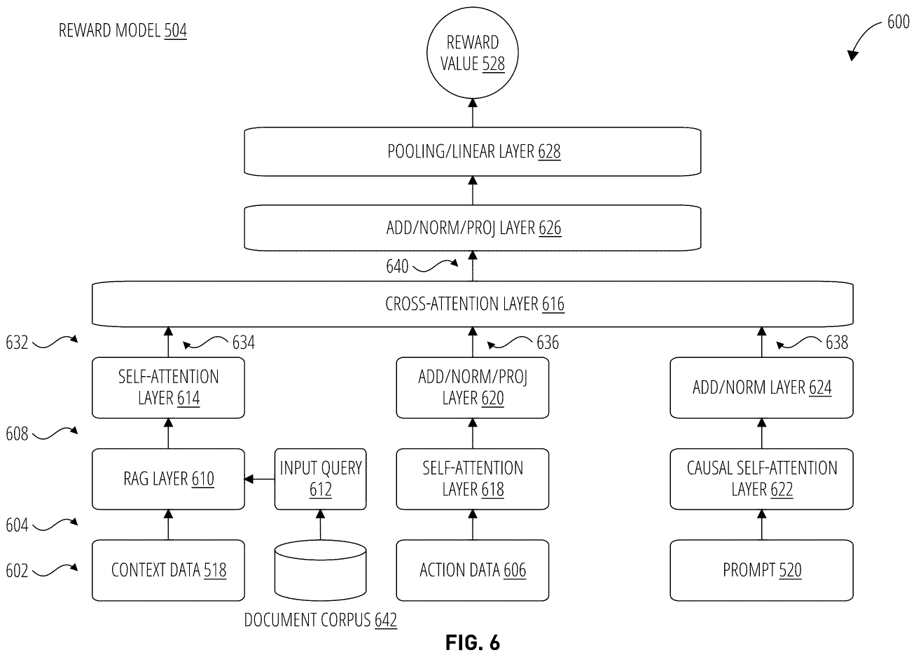

FIG. 6 illustrates a model architecture 600. The model architecture 600 is an example architecture for the reward model 504. Embodiments are not limited to this example.

As depicted in FIG. 6, the model architecture 600 comprises a set of ML layers for the reward model 504, where each layer performs a different function for the reward model 504. A conversion layer 602 receives raw data and converts the raw data into an input vector 604 for a transform layer 608. The input vector 604 comprises a feature set of context data 518, action data 606, and a prompt 520 for the reward model 504. The action data 606 is associated with an entity identifier for a campaign entity 302, such as entity data 128, entity activity data 130, or a combination of entity data 128 and entity activity data 130. The context data 518 is any data that provides context for a campaign entity 302 or a content delivery campaign 308. Non-limiting examples of context data 518 includes campaign attributes 310, campaign objectives, target audience members (e.g., demographics, education, job titles), platform data (e.g., mobile versus desktop), system tracking data, campaign performance metrics 422, content items 134 for the content delivery campaign 308, and so forth.

A transform layer 608 transforms the input vector 604 into a set of contextual embeddings 632, such as contextual embedding 634, contextual embedding 636, and contextual embedding 638. For example, a first tower transforms the context data 518 into a contextual embedding 634 using a RAG layer 610 and a self-attention layer 614. A second tower transforms the action data 606 into a contextual embedding 636 using a self-attention layer 618 and an add/norm/proj layer 620. A third tower transforms the prompt 520 into a contextual embedding 638 using a causal self-attention layer 622 and an add/norm layer 624.

The first tower uses a RAG layer 610 to assist in generating the contextual embedding 634. The RAG layer 610 combines retrieval-based methods with generative models to enhance the quality and relevance of outputs. It works by first retrieving relevant documents or data from a large document corpus 642 using an input query 612, then feeding this context into a generative model, like a transformer, to produce informed responses or predictions. In the context of a content delivery campaign 308, the RAG layer 610 can retrieve performance metrics 422, user behavior data, or demographic information from the document corpus 642, enabling the model to generate tailored recommendations grounded in real-time or historical data. This approach is particularly effective for dynamic tasks, as it leverages external knowledge without requiring the model to store all information internally, thus improving scalability and adaptability. For optimizing recommendations 440 in a content delivery campaign 308, the RAG layer 610 enhances audience targeting by analyzing performance metrics, such as click-through rates, conversions, or engagement levels. For instance, if certain audience segments underperform, the RAG layer 610 can retrieve data on these metrics, cross-reference it with user profiles or behavioral patterns, and suggest modifications to the target audience, like adjusting age groups or interests. By integrating this retrieved data into the generative process, the system can propose precise, data-driven recommendations, such as shifting ad placements to platforms frequented by high-performing segments or tweaking messaging to align with audience preferences, ultimately improving campaign efficiency and ROI.

In operation, the RAG layer 610 retrieves an input query 612 for the context data 518 of the input vector 604. The RAG layer 610 retrieves a set of documents relevant to the input query 612 from a document corpus 642. The RAG layer 610 generates modified context data 518 based on the set of documents. The RAG layer 610 generates a contextual embedding 634 for the set of contextual embeddings 632 from the modified context data 518 using the self-attention layer 614. The self-attention layer 614 enables a model to weigh the importance of different elements within a single input sequence by computing attention scores for each element relative to all others, capturing contextual relationships and dependencies. The self-attention layer 614 improves output quality by analyzing patterns within context data 518, such as current and past performance of a content delivery campaign 308 as captured by performance metrics 422 or time-series of performance metrics 422. For instance, self-attention can prioritize relevant campaign elements relevant to generating more coherent and personalized recommendations 440 that align more closely with a user's interests, thereby enhancing engagement and campaign effectiveness. The self-attention layer 614 outputs the contextual embedding 634 to the cross-attention layer 616.

The second tower transforms the action data 606 into a contextual embedding 636 using a self-attention layer 618 and an add/norm/proj layer 620. Similar to the first tower, the action data 606 is passed through a self-attention layer 618. The self-attention layer 618 enables a model to weigh the importance of different elements within a single input sequence by computing attention scores for each element relative to all others, capturing contextual relationships and dependencies. In a generative AI model for recommendations, self-attention can improve output quality by analyzing patterns within user data as expressed through the action data 606, such as browsing history, preferences, or demographic details, to identify key factors driving user behavior. For instance, self-attention can prioritize relevant user traits or past interactions to generate more coherent and personalized recommendations 440 that align more closely with a user's interests, thereby enhancing engagement and campaign effectiveness. The self-attention layer 618 passes output to an add/norm/proj layer 620.

In transformer models, an add/norm/proj layer 620 refers to a sequence of operations commonly used within the architecture: add (residual connection), norm (layer normalization), and proj (projection or linear transformation). The add step involves adding the input of a layer (e.g., from a self-attention or feed-forward module) to its output, creating a residual connection that helps stabilize training and mitigate vanishing gradients. The norm step applies layer normalization to standardize the output, reducing internal covariate shift and improving training stability. The proj step typically refers to a linear transformation (e.g., a fully connected layer) that projects the data into a different dimensional space, often used in feed-forward networks or to align dimensions in attention mechanisms. Together, these operations enhance model performance by improving gradient flow, stabilizing training, and enabling efficient feature transformation in tasks like natural language processing or recommendation systems.

The third tower transforms the prompt 520 into a contextual embedding 638 using a causal self-attention layer 622 and an add/norm layer 624. Similar to the first tower and the second tower, the third tower uses a form of self-attention by implementing a causal self-attention layer 622 to assist in generating the contextual embedding 638. The causal self-attention layer 622 is a variant of self-attention used in transformer models, where each element in a sequence attends only to preceding elements, ensuring that predictions are made sequentially and preventing future information from influencing past or current outputs, which is important for autoregressive tasks like text generation. In a generative AI model for recommendations, causal self-attention can improve the coherence and relevance of suggestions by processing prompt data, such as sequential interactions or preferences, in a time-ordered manner. For example, in an advertising recommendation system, it can analyze the prompt 520 to predict which aspects of the prompt 520 are more important when generating a recommendation 440. The causal self-attention layer 622 sends output to an add/norm layer 624. The add/norm layer 624 perform add (residual connection) and norm (layer normalization) operations on the output. The add step involves adding the input of a layer (e.g., from a self-attention or feed-forward module) to its output, creating a residual connection that helps stabilize training and mitigate vanishing gradients. The norm step applies layer normalization to standardize the output, reducing internal covariate shift and improving training stability. The add/norm layer 624 outputs the contextual embedding 638 to the cross-attention layer 616.

The cross-attention layer 616 receives the contextual embedding 634, the contextual embedding 636, and the contextual embedding 638 from the transform layer 608. The cross attention layer 616 processes the contextual embeddings 632 to generate a processed contextual embedding 640. The cross-attention layer 616 aligns and integrates information from multiple different sequences or data sources, such as the contextual embeddings 632. Unlike self-attention, which focuses on relationships within a single sequence, cross-attention computes attention scores between elements of one sequence (e.g., a query) and another (e.g., a context or memory), allowing the model to prioritize relevant information from the second sequence when processing the first. In essence, it enables the model to dynamically weigh and incorporate context-specific information, making it particularly useful in tasks like machine translation, question answering, or recommendation systems where external context enhances output relevance. The cross-attention layer 616 enhances model ability to tailor outputs by aligning user-specific data (e.g., preferences, behavior, or demographics) with broader contextual information (e.g., item features, trends, or campaign goals). For example, the cross-attention layer 616 focuses on relevant user attributes while simultaneously attending to performance metrics or product details, generating more personalized and contextually appropriate suggestions, such as targeting specific audience segments or optimizing ad content. By emphasizing the most relevant connections between user data and external context, the cross-attention layer 616 improves the precision and effectiveness of recommendations, leading to higher engagement and better campaign outcomes.

The cross-attention layer 616 processes the contextual embeddings 632 to generate a processed contextual embedding 640. The processed contextual embedding 640 is passed through an add/norm/proj layer 626 and a pooling/linear layer 628 to generate a reward value 528 for the recommendation 526.

As previously described with reference to FIG. 5, the model manager 506 executes the ML algorithm 508 to train the reward model 504 during a training phase 510. By way of example, let the language reward model be R. Given the generated text y, the past behavior of a campaign entity 302 (e.g., an advertiser/user) is shown in Equation (1) as follows:

b=[b₁, b₂, . . . , bₙ] Equation (1)

The additional context c (e.g., campaign performance measured by performance metrics 422), the reward model 504 predicts the reward R(y, b, c). In general, a language reward model can be constructed with an encoder or decoder-only model with the last layer swapped to a linear layer to produce the scalar value of the reward.

Given the collected feature y, b, c, and label (value of the action) V(a) where a is the resulting action after the campaign entity 302 (e.g., advertiser/user) observes the recommendation, the model manager 506 fits the reward model 504 during the training phase 510, as described with reference to FIG. 5. To mitigate the sparsity of action feedback, the model manager 506 leverages human preference data, such as selecting a conversion element 444 like a thumb up or thumb down in GUI view 400, as shown in Equations (2), (3), and (4) as follows:

V=E(value of text receives thumb up) Equation (2),

V=E(value of text receives thumb down) Equation (3)

V=E(value) Equation (4)

Equation (2) is an example of when the preference is a thumb up, Equation (3) is an example of when the preference is a thumb down, and Equation (4) is an example of there is no explicit preference, where the expectation is taken over advertisers or users in a cohort segmented based on business rule.

Since the mean squared error (MSE) may not be robust for positive-valued reward, the ML algorithm 508 applies MSE on the transformed label as shown in example Equation (5) as follows:

f(V(a)), where f(x)=log(1+x) Equation (5).

Additionally, or alternatively, the ML algorithm 508 leverages robust regression loss such as the Huber loss, the L₁ loss and Tukey's biweight or bisquare loss. In some embodiments, the ML algorithm 508 initializes most of the blocks with pre-trained LLMs or fine-tuned LLMs.

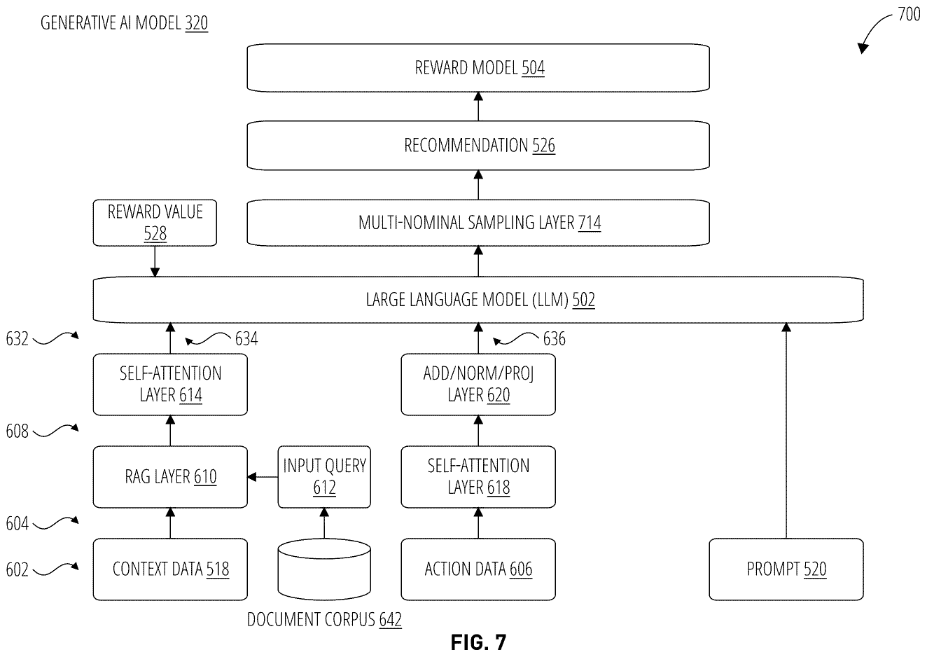

FIG. 7 illustrates a model architecture 700. The model architecture 700 is an example architecture for a generative AI model 320, such as LLM 502. Embodiments are not limited to this example.

As depicted in FIG. 7, the model architecture 700 comprises a set of ML layers for the generative AI model 320, where each layer performs a different function for the generative AI model 320. Similar to the model architecture 600, the model architecture 700 includes a conversion layer 602 that receives raw data and converts the raw data into an input vector 604 for a transform layer 608. The input vector 604 comprises a feature set of context data 518, action data 606, and a prompt 520 for the reward model 504. The action data 606 is associated with an entity identifier for a campaign entity 302, such as entity data 128, entity activity data 130, or a combination of entity data 128 and entity activity data 130.

A transform layer 608 transforms the input vector 604 into a set of contextual embeddings 632, such as contextual embedding 634, contextual embedding 636, and contextual embedding 638. For example, a tower to transform the context data 518 into a contextual embedding 634 includes a RAG layer 610 and a self-attention layer 614. The RAG layer 610 retrieves an input query 612 for the context data 518 of the input vector 604. The RAG layer 610 retrieves a set of documents relevant to the input query 612 from a document corpus 642. The RAG layer 610 generates modified context data 518 based on the set of documents. The RAG layer 610 generates a contextual embedding 634 for the set of contextual embeddings 632 from the modified context data 518 using the self-attention layer 614. Similar to model architecture 600, a tower to transform the action data 606 into a contextual embedding 636 includes a self-attention layer 618 and an add/norm/proj layer 620. Unlike the model architecture 600, the model architecture 700 does not perform any transformations for the prompt 520. Rather, the LLM 502 receives the prompt 520 and generates a recommendation 526 based on the instructions and information provided by the prompt 520.

The LLM 502 receives the reward value 528, the contextual embedding 634 and/or the contextual embedding 636 from the reward model 504. The LLM 502 performs fine-tuning or alignment operations using this information. Given the language reward model 504 as the judger, the ML algorithm 508 performs the alignment using a gradient-based method such as Proximal Policy Optimization (PPO). With the value-aligned LLM 502, the LLM 502 performs text generation in real-time and/or offline depending on the use cases. Multiple versions of text information 442 for multiple recommendations 526 are generated and passed to the ranking model 122. The ranking model 122 ranks the recommendations 526 based on the expected value. Recommendations 526 with top K values are retained and served to the GUI view 400 of the GUI 306 for viewing by the campaign entity 302 (e.g., advertiser/user). The resulting recommendation 526, if accepted by the campaign entity 302 via selection of the conversion element 444 to generate an interaction event 446, creates labeled feedback data that the ML algorithm 508 uses to tune the reward model R.

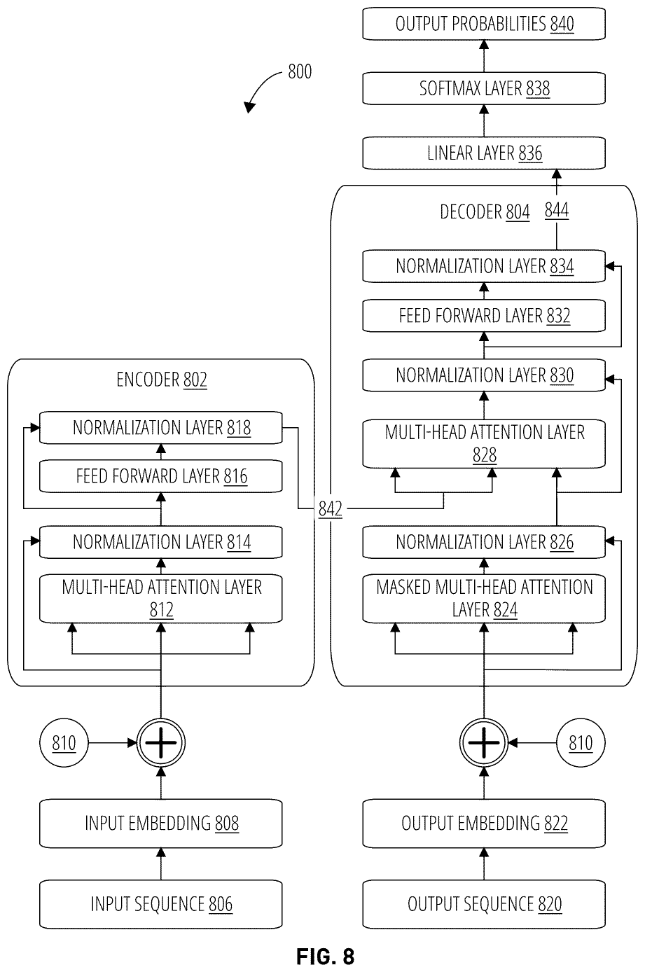

FIG. 8 illustrates a transformer model 800. The transformer model 800 is an example of a transformer architecture suitable for use by a generative AI model 320, such as model architecture 700 for LLM 502, for the content delivery system 300. In particular, the transformer model 800 is an example of a transformer architecture suitable for GPT, such as a version of ChatGPT. ChatGPT is trained on massive amounts of data, allowing it to generate text and respond to various prompts with human-like precision and accuracy. Embodiments are not limited to transformers.

As depicted in FIG. 8, the transformer model 800 comprises an encoder 802 and a decoder 804. The encoder 802 receives as input an input sequence 806, which is converted to an input embedding 808. A positional encoding 810 is added to the input embedding 808. The input embedding 808 with positional encoding 810 is input to the encoder 802. The encoder 802 comprises a multi-head attention layer 812, a normalization layer 814, a feed forward layer 816, and a normalization layer 818. The encoder 802 outputs an encoder output 842 to the decoder 804. The decoder 804 receives as input an output sequence 820, which is converted to an output embedding 822. A positional encoding 810 is added to the output embedding 822. The output embedding 822 with positional encoding 810 is input to the decoder 804. The decoder 804 comprises a masked multi-head attention layer 824, a normalization layer 826, a multi-head attention layer 828, a normalization layer 830, a feed forward layer 832, and a normalization layer 834.

Specifically, the encoder 802 is a neural sequence transduction model comprising an encoder 802 and a decoder 804. The encoder 802 receives an input sequence 806 and it translates the input sequence 806 into a lower-dimensional space. The encoder 802 maps an input sequence of symbol representations (x₁, . . . , xₙ) to a sequence of continuous representations z=(z₁, . . . , Zₙ). Given z, the decoder 804 then generates an output sequence (y₁, . . . , yₘ) of symbols one element at a time. At each step, the model is auto-regressive, consuming the previously generated symbols as additional input when generating the next. The decoder 804 translates the lower-dimensional data provided by the encoder 802 back to the original data format. Both the encoder 802 and the decoder 804 share three main types of layers, including a positional encoding layer, self-attention layer, and feedforward layer.

The encoder 802 transforms natural language input into numerical vectors. The encoder 802 receives an input sequence 806. The input sequence is a sequence of tokens (e.g., words or sub-words) that represent the text input. An input encoding layer of the encoder 802 converts the input sequence 806 into an input embedding 808. An input embedding 808 is a numerical representation of concepts converted to number sequences. The input embedding 808 is an NLP technique that represents words with vectors in such a way that once represented in a vectorial space, the mathematical distance between vectors is representative of the similarity among words they represent. For example, the content delivery application 120 may incorporate input embeddings to personalize, recommend, and search content. The input embedding 808 may comprise a matrix of vectors, where each vector represents a token in the sequence. The input embedding layer maps each token to a high-dimensional vector that captures the semantic meaning of the token.

Positional encoding 810 is a fixed, learned vector that represents a position of a word in the input sequence. It is added to the input embedding 808 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 808. The positional encoding is a vector that represents the position of each token in the sequence.

The encoder 802 includes multiple self-attention layers. The self-attention layers are responsible for determining the importance of each input token in generating the output. The self-attention layer allows the model to compute relationships between different parts of the input sequence 806. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 802 uses a multi-head attention layer 812. The multi-head attention layer 812 uses multiple self-attention layers operating in parallel on different parts of the input data, producing multiple representations. The multi-head attention layer 812 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 816.

The feed forward layer 816 comprises a series of fully connected layers and activation functions. The feed forward layer 816 transforms the output of the multi-head attention layer 812 into a suitable representation for the final output. The feed forward layer 816 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a ReLu. The output of the feed forward layer 816 is used as input to the next layer in the encoder 802.

The encoder 802 may also comprise a number of normalization layers, such as a normalization layer 814 and a normalization layer 818. The activations in each layer of the transformer architecture are normalized using layer normalization, which helps stabilize the training process and prevent the model from overfitting. A residual connection followed by layer normalization helps to stabilize the training process and make the model easier to train.

The output of the normalization layer 818 is the final output from the encoder 802 and it is a vector representation of the input sequence 806. The final output from the normalization layer 818 is used as input to the multi-head attention layer 828 of the decoder 804.

The decoder 804 decodes the input sequence 806 to the original data format. Similar to the encoder 802, the decoder 804 shares the core elements of positional encoding, self-attention, and feedforward layers. As depicted in transformer model 800, the decoder 804 comprises a masked multi-head attention layer 824, a normalization layer 826, a multi-head attention layer 828, a normalization layer 830, a feed forward layer 832, and a normalization layer 834. The decoder 804 outputs a decoder output 844 to a linear layer 836. The linear layer 836 is a feedforward network that adapts the dimension of the input to the dimension of the output. The output of the linear layer 836 feeds into a softmax layer 838. The softmax layer 838 transforms the input into a vector of probabilities. The output of the softmax layer 838 is a set of an output probabilities 840 for the transformer model 800. The transformer model 800 then picks the word corresponding to the highest probability and uses it as a best output of the model.

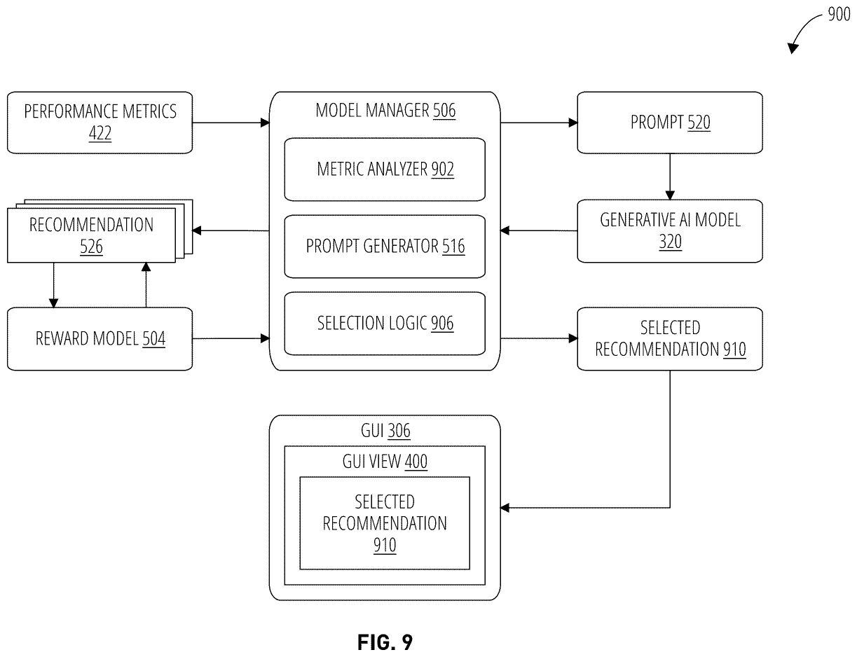

FIG. 9 illustrates a logic diagram 900. The logic diagram 900 is an example of inferencing operations performed by the model architecture 500, model architecture 600, model architecture 700, and/or transformer model 800. Embodiments are not limited to this example.

As depicted in FIG. 9, the logic diagram 900, during the inferencing phase 530 of the model architecture 500, a metric analyzer 902 of the model manager 506 receives a set of performance metrics 422 as described with reference to FIG. 4 and the context data 518 as described with reference to FIG. 5. The metric analyzer 902 analyzes the set of performance metrics 422 and the context data 518, and it outputs analysis results to the prompt generator 516 of the model manager 506. For example, the analysis results indicate a potential opportunity to target a new audience in an awareness campaign to gain a +15% CTR.

The prompt generator 516 receives the analysis results from the metric analyzer 902. The prompt generator 516 generates and sends a prompt 520 to a generative AI model 320, such as LLM 502. The prompt 520 comprises the set of performance metrics 422 and instructions for the generative AI model 320 to generate a recommendation 526 based on the set of performance metrics 422. The recommendation 526 comprises digital content information, such as text information 442, and a conversion element 444 for a GUI view 400 of a GUI 306. For example, the recommendation 526 provides a text description explaining that 42% of the members in a consideration phase are “Product Management” job function, compared to only 10% in the awareness step. The recommendation 526 requests to update an awareness audience to drive more members down a conversion funnel. The recommendation 526 has a conversion element 444 to “Create Audience” and/or other GUI elements, such as a “Dismiss” button to dismiss the recommendation 526.

The generative AI model 320, such as the LLM 502, generates the recommendation 526 and it is output to the reward model 504. The reward model 504 generates a reward value 528 for the recommendation 526. The reward value 528 indicates whether the digital content information, such as text information 442, of the recommendation 526 will cause the conversion element 444 to generate an interaction event 446 associated with the entity identifier. For example, the conversion element 444 is a GUI element from a set of GUI elements 402 of the GUI view 400 that when activated by an input device generates the interaction event 446. The LLM 502 receives the reward value 528 for the recommendation 526 from the reward model 504. In some embodiments, the model manager 506 performs multiple iterations to generate multiple recommendations 526. In some embodiments, for example, each recommendation 526 of the multiple recommendations 526 comprise different versions of a same recommendation, such as varying text information 442 for a given recommendation. In some embodiments, for example, each recommendation 526 of the multiple recommendations 526 comprise different recommendations.

Selection logic 906 of the model manager 506 determines whether to select the recommendation 526 for presentation on the GUI view 400 of the GUI 306 based on the reward value 528. The selection logic 906 causes presentation of the selected recommendation 910 on the GUI view 400 of the GUI 306.

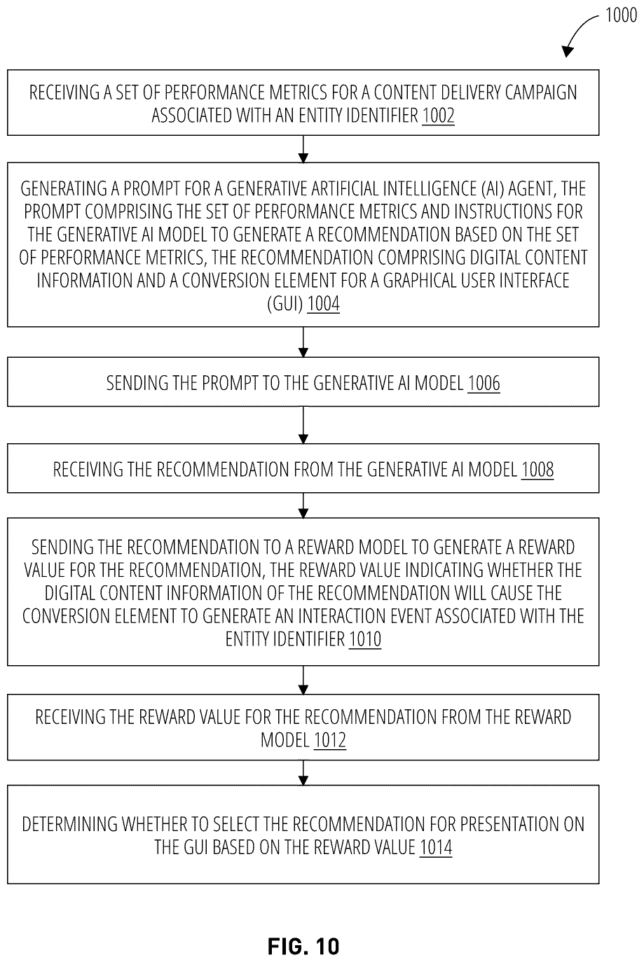

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the connection network platform 112 of the connection network system 100, such as the server device 102 and/or the client device 104. More particularly, the logic flow 1000 illustrates an example of operations for the connection network platform 112 of the connection network system 100, such as the content delivery application 120 for the content delivery system 300. For example, the logic flow 1000 may be performed by the server device 102 and/or the client device 104 using a system 200, content delivery system 300, GUI view 400, model architecture 500, model architecture 600, model architecture 700, transformer model 800, and/or logic diagram 900.

As depicted in logic flow 1000, at block 1002, the logic flow 1000 includes receiving a set of performance metrics for a content delivery campaign associated with an entity identifier. At block 1004, the logic flow 1000 includes sending a prompt to a generative artificial intelligence (AI) agent, the prompt comprising the set of performance metrics and instructions for the generative AI model to generate a recommendation based on the set of performance metrics, the recommendation comprising digital content information and a conversion element for a graphical user interface (GUI). At block 1004, the logic flow 1000 includes receiving the recommendation from the generative AI model. At block 1004, the logic flow 1000 includes sending the recommendation to a reward model to generate a reward value for the recommendation, the reward value indicating whether the digital content information of the recommendation will cause the conversion element to generate an interaction event associated with the entity identifier. At block 1004, the logic flow 1000 includes receiving the reward value for the recommendation from the reward model. At block 1004, the logic flow 1000 includes determining whether to select the recommendation for presentation on the GUI based on the reward value.

By way of example, with reference to the logic diagram 900 of FIG. 9, the model manager 506 receives a set of performance metrics 422 for a content delivery campaign 308 associated with an entity identifier for a campaign entity 302. A metric analyzer 902 analyzes the performance metrics 422 to identify an opportunity to improve the performance metrics 422 by modifying one or more campaign attributes 310 (e.g., campaign objectives) for the content delivery campaign 308. The metric analyzer 902 outputs analysis results to the prompt generator 516. The prompt generator 516 generates and sends a prompt 520 for a generative AI model 320, such as LLM 502. The prompt 520 comprises the set of performance metrics and instructions for the generative AI model 320 to generate a recommendation 526 based on the set of performance metrics 422. The recommendation 526 comprises digital content information, such as text information 442, and a conversion element 444 for a GUI view 400 of a GUI 306. The model manager 506 receives the recommendation 526 from the generative AI model 320, and it sends the recommendation 526 to a reward model 504. The reward model 504 generates a reward value 528 for the recommendation 526. The reward value 528 indicates whether the digital content information of the recommendation 526 will cause the conversion element 444 to generate an interaction event 446 associated with the entity identifier of the campaign entity 302. Selection logic 906 of the model manager 506 receives the reward value 528 for the recommendation 526 from the reward model 504. The selection logic 906 determines whether to select the recommendation 526 for presentation on the GUI view 400 of the GUI 306 based on the reward value 528.

In some embodiments, for example, the set of performance metrics 422 comprise an impression value, a click-through-rate (CTR) value, a conversion rate (CVR) value, or a qualified lead (QL) value.

In some embodiments, for example, the conversion element 444 is a GUI element that when activated by an input device generates the interaction event 446.

In some embodiments, for example, the reward model 504 receives an input vector 604 comprising a feature set of context data 518, action data 606, and the prompt 520. The action data 606 is associated with the entity identifier for the campaign entity 302. A transform layer 608 generates a set of contextual embeddings 632 for the feature set using multiple towers. For example, the transform layer 608 includes a first tower to transform the context data 518 to a contextual embedding 634 using a RAG layer 610 and a self-attention layer 614, a second tower to transform the action data 606 to a contextual embedding 636 using a self-attention layer 618 and an add/norm/proj layer 620, and a third tower to transform the prompt 520 to a contextual embedding 638 using a causal self-attention layer 622 and an add/norm layer 624. A cross-attention layer 616 generates a processed contextual embedding 640 for the set of contextual embeddings 632. The reward model 504 generates the reward value 528 based on the processed contextual embedding 640 after passing the processed contextual embedding 640 through an add/norm/proj layer 626 and a pooling/linear layer 628.

In some embodiments, for example, the generative AI model 320, such as LLM 502, receives an input vector 604 comprising a feature set of context data 518, action data 606, and the prompt 520. The action data 606 is associated with the entity identifier for the campaign entity 302. The transform layer 608 generates a set of contextual embeddings 632 for the context data 518 and the action data 606. For example, the transform layer 608 generates a contextual embedding 634 from the context data 518 using the first tower, and a contextual embedding 636 from the action data 606 using a second tower. In some embodiments, for example, the first tower and the second tower are the same as those used by the reward model 504. In some embodiments, for example, the LLM 502 receives the contextual embedding 634 and the contextual embedding 636 from the reward model 504. The LLM 502 generates the recommendation 526 based on the set of contextual embeddings 632 and the instructions from the prompt 520.

In some embodiments, for example, the RAG layer 610 of the first tower of the reward model 504 retrieves an input query 612 for the context data 518 of the input vector 604. The RAG layer 610 retrieves a set of documents relevant to the input query 612 from a document corpus 642. The RAG layer 610 generates modified context data 518 based on the set of documents, and it outputs the modified context data 518 to the self-attention layer 614. The self-attention layer 614 generates a contextual embedding 634 for the set of contextual embeddings 632 from the modified context data 518.

In some embodiments, for example, the RAG layer 610 of the first tower of the generative AI model 320, such as LLM 502, retrieves an input query 612 for the context data 518 of the input vector 604. The RAG layer 610 retrieves a set of documents relevant to the input query 612 from a document corpus 642. The RAG layer 610 generates modified context data 518 based on the set of documents, which is output to the self-attention layer 614. The self-attention layer 614 generates a contextual embedding 634 for the set of contextual embeddings 632 from the modified context data 518.

In some embodiments, for example, the model manager 506 receives a set of recommendations 526 from the generative AI model 320. The model manager 506 sends the set of recommendations 526 to the reward model 504. The reward model 504 generates a set of reward values 528 for the set of recommendations 526. The model manager 506 outputs the set of recommendations 526 and corresponding reward values 528 to a ranking model 122. The ranking model 122 ranks the set of recommendations 526 based on the reward values 528. The selection logic 906 (or recommendation model 124) selects the recommendation 526 having the highest rank from the ranked set of recommendations.

In some embodiments, for example, the generative AI model 320 is a multi-modal machine learning (ML) model that generates digital content information for the recommendation 526. The digital content information comprises text information, visual information, or audio information.

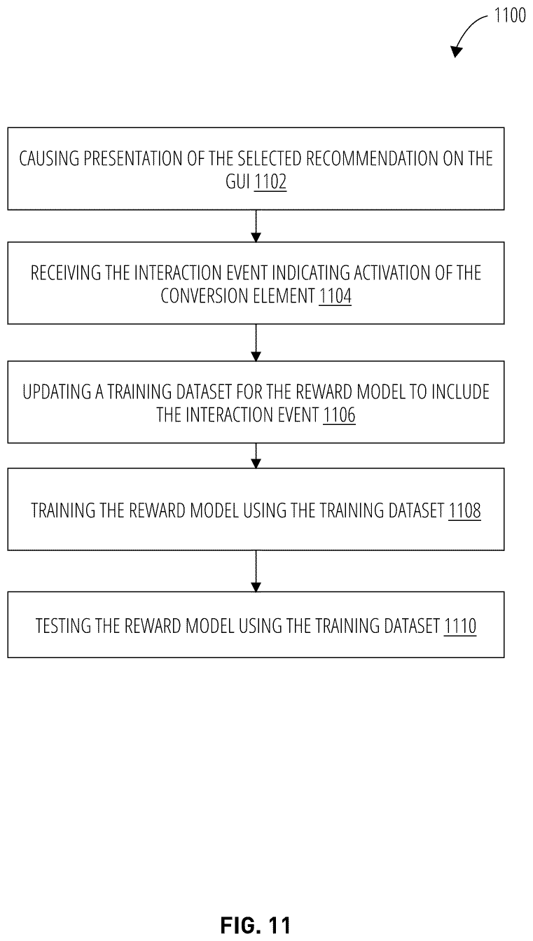

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the connection network platform 112 of the connection network system 100, such as the server device 102 and/or the client device 104. More particularly, the logic flow 1100 illustrates an example of operations for the connection network platform 112 of the connection network system 100, such as the content delivery application 120 for the content delivery system 300. For example, the logic flow 1000 may be performed by the server device 102 and/or the client device 104 using a system 200, content delivery system 300, GUI view 400, model architecture 500, model architecture 600, model architecture 700, transformer model 800, logic diagram 900, and/or logic flow 1000.

As depicted in logic flow 1100, at block 1102 the logic flow 1100 causes presentation of the selected recommendation on the GUI view of the GUI. At block 1104, the logic flow 1100 receives the interaction event indicating activation of the conversion element. At block 1106, the logic flow 1100 updates a training dataset for the reward model to include a training sample with the interaction event. At block 1108, the logic flow 1100 trains the reward model using the training sample of the training dataset. At block 1110, the logic flow 1100 tests the reward model 504 using the training dataset.

By way of example, the model manager 506 causes presentation of the selected recommendation 910 on the GUI view 400 of the GUI 306. The model manager 506 receives the interaction event 446 indicating activation of the conversion element 444. The model manager 506 updates a training dataset 514 for the reward model 504 to include a new training sample 512 with the interaction event 446. The model manager 506 executes the ML algorithm 508 for training (or retraining) the reward model 504 using the new training samples 512 of the training dataset 514. The model manager 506 tests the reward model 504 using some of the training samples 512 of the training dataset 514.

FIG. 12 illustrates an apparatus 1200. The apparatus 1200 depicts a training device 1202 suitable for training an ML model 1220 for the connection network system 100, such as the ML models 230, generative AI model 320, LLM 502, and/or reward model 504. Specifically, the training device 1202 trains the ML model 1220 to perform inferencing operations in support of the content delivery application 120 of the content delivery system 300.

As depicted in FIG. 12, the training device 1202 includes a processing circuitry 1204 and a memory unit 1206. The memory unit 1206 may store a set of ML components 1208 to support various AI/ML techniques. The ML components 1208 comprise a data collector 1210, a model trainer 1212, a model evaluator 1214 and a model inferencer 1216.

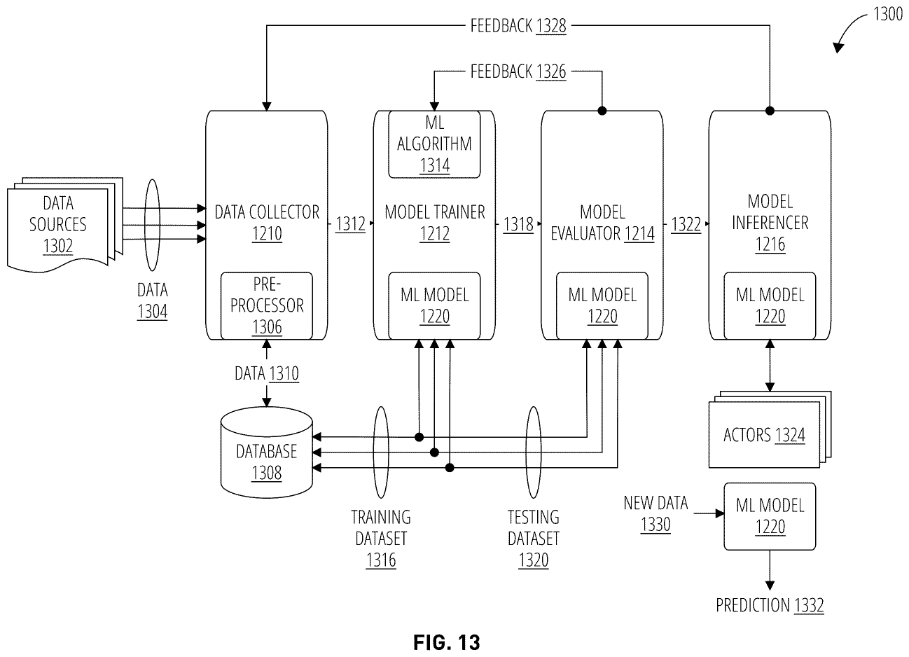

In general, the data collector 1210 collects data 1218 from one or more data sources to use as training data for an ML model 1220. The data collector 1210 collects different types of data 1218, such as text information, audio information, image information, video information, graphic information, and so forth. The model trainer 1212 receives as input the collected data and uses a portion of the collected data as test data for an AI/ML algorithm to train the ML model 1220. The model evaluator 1214 evaluates and improves the trained ML model 1220 using a portion of the collected data as test data to test the ML model 1220. The model evaluator 1214 also uses feedback information from the deployed ML model 1220. The model inferencer 1216 implements the trained ML model 1220 to receive as input new unseen data, generate one or more inferences on the new data, and output a result such as an alert, a recommendation or other post-solution activity. An exemplary AI/ML architecture for the ML components 1208 is described in more detail with reference to FIG. 13.

FIG. 13 illustrates a logic diagram 1300 suitable for use by the training device 1202 to generate the ML model 1220 for deployment by an inferencing device of the connection network platform 112. The logic diagram 1300 is an example of a system suitable for implementing various AI techniques and/or ML techniques to perform various training tasks on behalf of the various devices of the connection network system 100.

In one embodiment, the training device 1202 trains an ML model 1220. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 1202 may pretrain an ML model 1220 before training the ML model 1220 or trains a pretrained ML model 1220. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 1300 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1220, evaluate performance of the trained ML model 1220, and deploy the tested ML model 1220 as the trained ML model 1220 in a production environment, and continuously monitor and maintain it.

The ML model 1220 is a mathematical construct used to predict outcomes based on a set of input data. The ML model 1220 is trained using large volumes of training dataset 1316, and it can recognize patterns and trends in the training dataset 1316 to make accurate predictions. The ML model 1220 is derived from an ML algorithm 1314. A data set is fed into the ML algorithm 1314 which trains an ML model 1220 to “learn” a function that produces mappings between a set of inputs and a set of outputs with a reasonably high accuracy. Given a sufficiently large enough set of inputs and outputs, the ML algorithm 1314 finds the function for a given task. This function may even be able to produce the correct output for input that it has not seen during training. A data scientist prepares the mappings, selects and tunes the ML algorithm 1314, and evaluates the resulting model performance. Once the ML model 1220 is sufficiently accurate on test data, it can be deployed for production use.

The ML algorithm 1314 is generally a computational procedure used to identify patterns within data and make inferences or predictions without being explicitly programmed for every scenario. The ML algorithm 1314 can process input data, learn from it by adjusting internal parameters, and then apply the learned information to new, unseen data. The ML algorithm 1314 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time consuming to obtain, and where the goal is to improve the accuracy of predictions or classifications by leveraging large amounts of unlabeled data.

The ML algorithm 1314 of the logic diagram 1300 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 13, the logic diagram 1300 includes a set of data sources 1302 to source data 1304 for the training device 1202. Data sources 1302 may comprise any device capable generating, processing, storing or managing data 1304 suitable for a ML system. Examples of data sources 1302 include without limitation databases, web scraping, sensors and Internet of Things (IOT) devices, image and video cameras, audio devices, text generators, publicly available databases, private databases, and many other data sources 1302. The data sources 1302 may be remote from the training device 1202 and accessed via a network, local to the training device 1202 and accessed via a network interface, or may be a combination of local and remote data sources 1302.

The data sources 1302 source difference types of data 1304. By way of example and not limitation, the data 1304 includes structured data from relational databases, such as customer profiles, transaction histories, or product inventories. The data 1304 includes unstructured data from websites such as customer reviews, news articles, social media posts, or product specifications. The data 1304 includes data from temperature sensors, motion detectors, and smart home appliances. The data 1304 includes image data from medical images, security footage, or satellite images. The data 1304 includes audio data from speech recognition, music recognition, or call centers. The data 1304 includes text data from emails, chat logs, customer feedback, news articles or social media posts. The data 1304 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1304 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1302 are communicatively coupled to a data collector 1210. The data collector 1210 gathers relevant data 1304 from the data sources 1302. Once collected, the data collector 1210 may use a pre-processor 1306 to make the data 1304 suitable for analysis. This involves data cleaning, transformation, and feature engineering. Data preprocessing is a critical step in ML as it directly impacts the accuracy and effectiveness of the ML model 1220. The pre-processor 1306 receives the data 1304 as input, processes the data 1304, and outputs pre-processed data 1310 for storage in a database 1308. Examples for the database 1308 includes a hard drive, solid state storage, and/or random access memory (RAM).

The data collector 1210 is communicatively coupled to a model trainer 1212. The model trainer 1212 performs AI/ML model training, validation, and testing which may generate model performance metrics as part of the model testing procedure. The model trainer 1212 receives the pre-processed data 1310 as input 1312 or via the database 1308. The model trainer 1212 implements a suitable ML algorithm 1314 to train an ML model 230 on a set of training dataset 1316 from the pre-processed data 1310. The training process involves feeding the pre-processed data 1310 into the ML algorithm 1314 to produce or optimize an ML model 1220. The training process adjusts its parameters until it achieves an initial level of satisfactory performance.

The model trainer 1212 is communicatively coupled to a model evaluator 1214. After an ML model 1220 is trained, the ML model 1220 needs to be evaluated to assess its performance. This is done using various metrics such as accuracy, precision, recall, and F1 score. The model trainer 1212 outputs the ML model 1220, which is received as input 1312 or from the database 1308. The model evaluator 1214 receives the ML model 230 as input 1318, and it initiates an evaluation process to measure performance of the ML model 1220. The evaluation process includes providing feedback 1326 to the model trainer 1212. The model trainer 1212 re-trains the ML model 1220 to improve performance in an iterative manner.

The model evaluator 1214 is communicatively coupled to a model inferencer 1216. The model inferencer 1216 provides AI/ML model inference output (e.g., inferences, predictions or decisions). Once the ML model 1220 is trained and evaluated, it is deployed in a production environment where it is used to make predictions on new data. The model inferencer 1216 receives the evaluated ML model 1220 as input 1322. The model inferencer 1216 uses the evaluated ML model 1220 to produce insights or predictions on real data, which is deployed as a final production ML model 1220. The inference output of the ML model 1220 is use case specific. The model inferencer 1216 also performs model monitoring and maintenance, which involves continuously monitoring performance of the ML model 1220 in the production environment and making any necessary updates or modifications to maintain its accuracy and effectiveness. The model inferencer 1216 provides feedback 1326 to the data collector 1210 to train or re-train the ML model 1220. The feedback 1326 includes model performance feedback information, which is used for monitoring and improving performance of the ML model 1220.

Some or all of the model inferencer 1216 is implemented by various actors 1324 in the logic diagram 1300, including the ML model 1220 of the connection network platform 112, for example. The actors 1324 use the deployed ML model 1220 on new data to make inferences or predictions for a given task, and output a prediction 1332. The actors 1324 implement the model inferencer 1216 locally, or remotely receives outputs from the model inferencer 1216 in a distributed computing manner. The actors 1324 trigger actions directed to other entities or to itself. The actors 1324 provide feedback 1328 to the data collector 1210 via the model inferencer 1216. The feedback 1328 comprise data needed to derive training data, inference data or to monitor the performance of the ML model 1220 and its impact to the network through updating of key performance indicators (KPIs) and performance counters.

As previously described with reference to FIGS. 1, 2, the connection network system 100 and/or the apparatus 1200 may implement some or all of the logic diagram 1300 to support various use cases and solutions for various AI/ML tasks. In various embodiments, the training device 1202 of the apparatus 1200 uses the logic diagram 1300 to generate and train the ML model 230 for use by the connection network platform 112 for the client application 110. In one embodiment, for example, the training device 1202 may train the ML model 1220 as a neural network. Other use cases and solutions for AI/ML are possible as well, and embodiments are not limited in this context.

FIG. 14 illustrates an embodiment of a computing architecture 1400. Computing architecture 1400 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1400 has a single processor with one core or more than one processor. Note that the term “processor” refers to a processor with a single core or a processor package with multiple processor cores. In at least one embodiment, the computing architecture 1400 is representative of the components of the system 200. More generally, the computing architecture 1400 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1400. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 14, computing architecture 1400 comprises a system-on-chip (SoC) 1402 for mounting platform components. System-on-chip (SoC) 1402 is a point-to-point (P2P) interconnect platform that includes a first processor 1404 and a second processor 1406 coupled via a point-to-point interconnect 1470 such as an Ultra Path Interconnect (UPI). In other embodiments, the computing architecture 1400 is another bus architecture, such as a multi-drop bus. Furthermore, each of processor 1404 and processor 1406 are processor packages with multiple processor cores including core(s) 1408 and core(s) 1410, respectively. While the computing architecture 1400 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1404 and chipset 1432. Some platforms include additional components and some platforms include sockets to mount the processors and/or the chipset. Furthermore, some platforms do not have sockets (e.g. SoC, or the like). Although depicted as a SoC 1402, one or more of the components of the SoC 1402 are included in a single die package, a multi-chip module (MCM), a multi-die package, a chiplet, a bridge, and/or an interposer. Therefore, embodiments are not limited to a SoC.

The processor 1404 and processor 1406 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1404 and/or processor 1406. Additionally, the processor 1404 need not be identical to processor 1406.

Processor 1404 includes an integrated memory controller (IMC) 1420 and point-to-point (P2P) interface 1424 and P2P interface 1428. Similarly, the processor 1406 includes an IMC 1422 as well as P2P interface 1426 and P2P interface 1430. IMC 1420 and IMC 1422 couple the processor 1404 and processor 1406, respectively, to respective memories (e.g., memory 1416 and memory 1418). Memory 1416 and memory 1418 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1416 and the memory 1418 locally attach to the respective processors (i.e., processor 1404 and processor 1406). In other embodiments, the main memory couple with the processors via a bus and shared memory hub. Processor 1404 includes registers 1412 and processor 1406 includes registers 1414.

Computing architecture 1400 includes chipset 1432 coupled to processor 1404 and processor 1406. Furthermore, chipset 1432 are coupled to storage device 1450, for example, via an interface (I/F) 1438. The I/F 1438 may be, for example, a Peripheral Component Interconnect-enhanced (PCIe) interface, a Compute Express Link® (CXL) interface, or a Universal Chiplet Interconnect Express (UCIe) interface. Storage device 1450 stores instructions executable by circuitry of computing architecture 1400 (e.g., processor 1404, processor 1406, GPU 1448, accelerator 1454, vision processing unit 1456, or the like). For example, storage device 1450 can store instructions for the client device 202, the client device 206, the inferencing device 204, the training device 1202, or the like.

Processor 1404 couples to the chipset 1432 via P2P interface 1428 and P2P 1434 while processor 1406 couples to the chipset 1432 via P2P interface 1430 and P2P 1436. Direct media interface (DMI) 1476 and DMI 1478 couple the P2P interface 1428 and the P2P 1434 and the P2P interface 1430 and P2P 1436, respectively. DMI 1476 and DMI 1478 is a high-speed interconnect that facilitates, e.g., eight Giga Transfers per second (GT/s) such as DMI 3.0. In other embodiments, the processor 1404 and processor 1406 interconnect via a bus.

The chipset 1432 comprises a controller hub such as a platform controller hub (PCH). The chipset 1432 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1432 comprises more than one controller hub such as a chipset with a memory controller hub, a graphics controller hub, and an input/output (I/O) controller hub.

In the depicted example, chipset 1432 couples with a trusted platform module (TPM) 1444 and UEFI, BIOS, FLASH circuitry 1446 via I/F 1442. The TPM 1444 is a dedicated microcontroller designed to secure hardware by integrating cryptographic keys into devices. The UEFI, BIOS, FLASH circuitry 1446 may provide pre-boot code. The I/F 1442 may also be coupled to a network interface circuit (NIC) 1480 for connections off-chip.

Furthermore, chipset 1432 includes the I/F 1438 to couple chipset 1432 with a high-performance graphics engine, such as, graphics processing circuitry or a graphics processing unit (GPU) 1448. In other embodiments, the computing architecture 1400 includes a flexible display interface (FDI) (not shown) between the processor 1404 and/or the processor 1406 and the chipset 1432. The FDI interconnects a graphics processor core in one or more of processor 1404 and/or processor 1406 with the chipset 1432.

The computing architecture 1400 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3—related media and functions).

Additionally, accelerator 1454 and/or vision processing unit 1456 are coupled to chipset 1432 via I/F 1438. The accelerator 1454 is representative of any type of accelerator device (e.g., a data streaming accelerator, cryptographic accelerator, cryptographic co-processor, an offload engine, etc.). One example of an accelerator 1454 is the Intel® Data Streaming Accelerator (DSA). The accelerator 1454 is a device including circuitry to accelerate copy operations, data encryption, hash value computation, data comparison operations (including comparison of data in memory 1416 and/or memory 1418), and/or data compression. Examples for the accelerator 1454 include a USB device, PCI device, PCIe device, CXL device, UCIe device, and/or an SPI device. The accelerator 1454 also includes circuitry arranged to execute machine learning (ML) related operations (e.g., training, inference, etc.) for ML models. Generally, the accelerator 1454 is specially designed to perform computationally intensive operations, such as hash value computations, comparison operations, cryptographic operations, and/or compression operations, in a manner that is more efficient than when performed by the processor 1404 or processor 1406. Because the load of the computing architecture 1400 includes hash value computations, comparison operations, cryptographic operations, and/or compression operations, the accelerator 1454 greatly increases performance of the computing architecture 1400 for these operations.

The accelerator 1454 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1454. For example, the accelerator 1454 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1454 via a non-posted write (e.g., a deferred memory write (DMWr)). One example of an instruction that atomically submits a work descriptor to the shared work queue of the accelerator 1454 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1454. The dedicated work queue may accept job submissions via commands such as the movdir64b instruction.

Various I/O devices 1460 and display 1452 couple to the bus 1472, along with a bus bridge 1458 which couples the bus 1472 to a second bus 1474 and an I/F 1440 that connects the bus 1472 with the chipset 1432. In one embodiment, the second bus 1474 is a low pin count (LPC) bus. Various input/output (I/O) devices couple to the second bus 1474 including, for example, a keyboard 1462, a mouse 1464 and communication devices 1466.

Furthermore, an audio I/O 1468 couples to second bus 1474. Many of the I/O devices 1460 and communication devices 1466 reside on the system-on-chip (SoC) 1402 while the keyboard 1462 and the mouse 1464 are add-on peripherals. In other embodiments, some or all the I/O devices 1460 and communication devices 1466 are add-on peripherals and do not reside on the system-on-chip (SoC) 1402.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

1. A method, comprising:
receiving a set of performance metrics for a content delivery campaign associated with an entity identifier;
sending a prompt to a generative artificial intelligence (AI) model, the prompt comprising the set of performance metrics and instructions for the generative AI model to generate a recommendation based on the set of performance metrics, the recommendation comprising digital content information and a conversion element for a graphical user interface (GUI);
receiving the recommendation from the generative AI model;
sending the recommendation to a reward model to generate a reward value for the recommendation, the reward value indicating whether the digital content information is configured to cause the conversion element to generate an interaction event associated with the entity identifier, wherein generating the reward value comprises:
receiving an input vector comprising a feature set of context data. action data, and the prompt by the reward model, wherein the action data is associated with the entity identifier;
generating a set of contextual embeddings for the feature set using a self-attention layer and a causal self-attention layer of the reward model;
generating a processed contextual embedding for the set of contextual embeddings using a cross-attention layer of the reward model; and
generating the reward value based on the processed contextual embedding;
receiving the reward value for the recommendation from the reward model; and
selecting the recommendation for presentation on the GUI in response to the reward value satisfying a threshold value.

2. The method of claim 1, wherein the set of performance metrics comprises an impression value, a click-through-rate (CTR) value, a conversion rate (CVR) value, or a qualified lead (QL) value.

3. The method of claim 1, wherein the conversion element is a GUI element that when activated by an input device generates the interaction event.

4. The method of claim 1, comprising:
causing presentation of the selected recommendation on the GUI;
receiving the interaction event indicating activation of the conversion element;
updating a training dataset for the reward model to include the interaction event; and
training the reward model using the updated training dataset.

5. (canceled)

6. The method of claim 1, comprising:
retrieving an input query for the context data of the input vector by a retrieval-augmented generation (RAG) layer of the reward model;
retrieving a set of documents relevant to the input query from a document corpus by the RAG layer of the reward model;
generating modified context data based on the set of documents by the RAG layer of the reward model; and
generating a contextual embedding for the set of contextual embeddings from the modified context data using the self-attention layer of the reward model.

7. The method of claim 1, comprising:
receiving an input vector comprising the feature set of the context data, the action data, and the prompt by the generative AI model, wherein the action data is associated with the entity identifier;
generating a second set of contextual embeddings for the context data and the action data by a self-attention layer of the generative AI model; and
generating the recommendation based on the second set of contextual embeddings and the instructions from the prompt by a large language model (LLM) of the generative AI model.

8. The method of claim 7, comprising:
retrieving an input query for the context data of the input vector by a retrieval-augmented generation (RAG) layer of the generative AI model;
retrieving a set of documents relevant to the input query from a document corpus by the RAG layer of the generative AI model;
generating modified context data based on the set of documents by the RAG layer of the generative AI model; and
generating a contextual embedding for the second set of contextual embeddings from the modified context data using the self-attention layer of the generative AI model.

9. The method of claim 1, comprising:
receiving a set of recommendations from the generative AI model;
sending the set of recommendations to the reward model;
generating a set of reward values for the set of recommendations by the reward model;
ranking the set of recommendations based on the set of reward values; and
selecting the recommendation having the highest rank from the ranked set of recommendations.

10. The method of claim 1, comprising jointly training the generative AI agent and the reward model using training samples from a training dataset, wherein a training sample comprises entity data and entity activity data associated with the entity identifier, the entity activity data comprising historical data of past actions taken by an entity associated with the entity identifier.

11. A computing apparatus comprising:
circuitry; and
a memory storing instructions that, when executed by the circuitry, cause the circuitry to:
receive a set of performance metrics for a content delivery campaign associated with an entity identifier;
send a prompt to a generative artificial intelligence (AI) model, the prompt comprising the set of performance metrics and instructions for the generative AI model to generate a recommendation based on the set of performance metrics, the recommendation comprising digital content information and a conversion element for a graphical user interface (GUI);
receive the recommendation from the generative AI model;
send the recommendation to a reward model to generate a reward value for the recommendation, the reward value indicating whether the digital content information is configured to cause the conversion element to generate an interaction event associated with the entity identifier, wherein generation of the reward value comprises:
receive an input vector comprising a feature set of context data, action data, and the prompt by the reward model, wherein the action data is associated with the entity identifier;
generate a set of contextual embeddings for the feature set using a self-attention layer and a causal self-attention layer of the reward model;
generate a processed contextual embedding for the set of contextual embeddings using a cross-attention layer of the reward model; and
generate the reward value based on the processed contextual embedding;
receive the reward value for the recommendation from the reward model; and
select the recommendation for presentation on the GUI in response to the reward value satisfying a threshold value.

12. The computing apparatus of claim 11, wherein the set of performance metrics comprises an impression value, a click-through-rate (CTR) value, a conversion rate (CVR) value, or a qualified lead (QL) value.

13. The computing apparatus of claim 11, the circuitry to:
cause presentation of the selected recommendation on the GUI;
receive the interaction event indicating activation of the conversion element;
update a training dataset for the reward model to include the interaction event; and
train the reward model using the updated training dataset.

14. (canceled)

15. The computing apparatus of claim 11, the circuitry to:
retrieve an input query for the context data of the input vector by a retrieval-augmented generation (RAG) layer of the reward model;
retrieve a set of documents relevant to the input query from a document corpus by the RAG layer of the reward model;
generate modified context data based on the set of documents by the RAG layer of the reward model; and
generate a contextual embedding for the set of contextual embeddings from the modified context data using the self-attention layer of the reward model.

16. The computing apparatus of claim 11, the circuitry to:
receive an input vector comprising the feature set of the context data, the action data, and the prompt by the generative AI model, wherein the action data is associated with the entity identifier;
generate a second set of contextual embeddings for the context data and the action data by a self-attention layer of the generative AI model; and
generate the recommendation based on the second set of contextual embeddings and the instructions from the prompt by a large language model (LLM) of the generative AI model.

17. The computing apparatus of claim 16, the circuitry to:
retrieve an input query for the context data of the input vector by a retrieval-augmented generation (RAG) layer of the generative AI model;
retrieve a set of documents relevant to the input query from a document corpus by the RAG layer of the generative AI model;
generate modified context data based on the set of documents by the RAG layer of the generative AI model; and
generate a contextual embedding for the second set of contextual embeddings from the modified context data using the self-attention layer of the generative AI model.

18. The computing apparatus of claim 11, the circuitry to:
receive a set of recommendations from the generative AI model;
send the set of recommendations to the reward model;
generate a set of reward values for the set of recommendations by the reward model;
rank the set of recommendations based on the reward values; and
select the recommendation having the highest rank from the ranked set of recommendations.

19. A non-transitory computer-readable storage medium, the computer-readable storage medium including instructions that when executed by circuitry, cause the circuitry to:
receive a set of performance metrics for a content delivery campaign associated with an entity identifier;
send a prompt to a generative artificial intelligence (AI) model, the prompt comprising the set of performance metrics and instructions for the generative AI model to generate a recommendation based on the set of performance metrics, the recommendation comprising digital content information and a conversion element for a graphical user interface (GUI);
receive the recommendation from the generative AI model;
send the recommendation to a reward model to generate a reward value for the recommendation, the reward value indicating whether the digital content information is configured to cause the conversion element to generate an interaction event associated with the entity identifier, wherein generation of the reward value comprises:
receive an input vector comprising a feature set of context data, action data, and the prompt by the reward model, wherein the action data is associated with the entity identifier;
generate a set of contextual embeddings for the feature set using a self-attention layer and a causal self-attention layer of the reward model;
generate a processed contextual embedding for the set of contextual embeddings using a cross-attention layer of the reward model; and
generate the reward value based on the processed contextual embedding;
receive the reward value for the recommendation from the reward model; and
select the recommendation for presentation on the GUI in response to the reward value satisfying a threshold value.

20. The computer-readable storage medium of claim 19, including instructions that when executed by circuitry, cause the circuitry to:
cause presentation of the selected recommendation on the GUI;
receive the interaction event indicating activation of the conversion element;
update a training dataset for the reward model to include the interaction event; and
train the reward model using the updated training dataset.
